(19) United States
(12) Patent Application Publication
(10) Pub. No.: US 2015/0312569 A1
(43) Pub. Date: Oct. 29, 2015

(54) IMAGE PROCESSING APPARATUS, IMAGE PROCESSING METHOD, AND PROGRAM

(71) Applicant: SONY CORPORATION, Minato-ku, Tokyo (JP)

(72) Inventor: YUICHI ARAKI, TOKYO (JP)

(73) Assignee: SONY CORPORATION, MINATO-KU, TOKYO (JP)

(21) Appl. No.: 14/647,692

(22) PCT Filed: Nov. 25, 2013
(86) PCT No.: PCT/JP2013/081596

§ 371 Date: May 27, 2015

(30) Foreign Application Priority Data
Jun. 6, 2012 (JP) 2012-267400

(51) Int. Cl. H04N 19/117; H04N 19/176; H04N 19/182; H04N 19/86; H04N 19/436; H04N 19/80

(52) U.S. Cl. CPC H04N 19/117; H04N 19/436; H04N 19/80; H04N 19/182; H04N 19/86; H04N 19/176

(57) ABSTRACT

The present technology relates to an image processing apparatus, an image processing method, and a program, in which a filter process on a decoded image is performed in parallel in a processing unit regardless of a parallel encoding processing unit. An addition unit decodes encoding data and generates an image. A deblocking filter, an adaptive offset filter, and an adaptive loop filter perform the filter process in a parallel processing unit regardless of a slice in parallel on the image generated by the addition unit. The present technology, for example, can be applied to an encoding apparatus and a decoding apparatus.

### TECHNICAL FIELD

The present technology relates to an image processing apparatus, an image processing method, and a program, and particularly to an image processing apparatus, an image processing method, and a program, in which a filter process on a decoded image is performed in parallel in a processing unit regardless of a parallel encoding processing unit.

### BACKGROUND ART

Standardization on an encoding system called HEVC (High Efficiency Video Coding) is ongoing for the purpose of an improvement in encoding efficiency of a moving image (for example, see Non-Patent Document 1). In the HEVC system, a slice and a tile can be used as a parallel encoding processing unit which is an encoding processing unit capable of performing the decoding in parallel.

### CITATION LIST

### Non-Patent Document

Non-Patent Document 1: Benjamin Bross, Woo-Jin Han, Jens-Rainer Ohm, Gary J. Sullivan, Thomas Wiegand, “High efficiency video coding (HEVC) text specification draft 8”, JCTVC-J1003_d7, 2012 Jul. 28

### SUMMARY OF THE INVENTION

### Problems to be Solved by the Invention

However, a filter process performed on a decoded image at the time of encoding or decoding has not been considered to be performed in parallel in a processing unit regardless of a parallel encoding processing unit.

The present technology has been made in view of such a circumstance, and an object thereof is to perform the filter process in the processing unit regardless of the parallel encoding processing unit in parallel on the decoded image.

### Solutions to Problems

An image processing apparatus according to a first aspect of the present technology is an image processing apparatus including: a decoding unit configured to decode encoding data and generate an image; and a filter processing unit configured to perform a filter process in a processing unit regardless of a slice in parallel on the image generated by the decoding unit.

An image processing method and a program according to the first aspect of the present technology correspond to an image processing apparatus according to the first aspect of the present technology.

In the first aspect of the present technology, the encoding data is decoded to generate the image, and the filter process is performed in the processing unit regardless of the slice in parallel on the image.

An image processing apparatus according to a second aspect of the present technology corresponds to an image processing apparatus which includes a decoding unit configured to decode encoding data and generate an image, and a filter processing unit configured to perform a filter process in a processing unit regardless of a tile in parallel on the image generated by the decoding unit.

In the second aspect of the present technology, the encoding data is decoded to generate the image, and the filter process is performed in the processing unit regardless of the tile in parallel on the image.

### Effects of the Invention

According to the present technology, a filter process on a decoded image can be performed in parallel in a processing unit regardless of a parallel encoding processing unit.

### BRIEF DESCRIPTION OF DRAWINGS

FIG. 1 is a block diagram illustrating an exemplary configuration of a first embodiment of an encoding apparatus to which the present technology is applied.

FIG. 2 is a diagram for describing an LCU which is a maximum coding unit in an HEVC system.

FIG. 3 is a diagram illustrating an example of a parallel processing unit in an inverse quantization, an inverse orthogonal transform, an addition process, and a compensation process.

FIG. 4 is a block diagram illustrating an exemplary configuration of a deblocking filter of FIG. 1.

FIG. 5 is a diagram for describing a parallel processing unit of a deblocking filter process on a luminance component of an image.

FIG. 6 is a diagram for describing the parallel processing unit of the deblocking filter process on the luminance component of the image.

FIG. 7 is a diagram for describing the parallel processing unit of the deblocking filter process on the luminance component of the image.

FIG. 8 is a diagram for describing the parallel processing unit of the deblocking filter process on the luminance component of the image.

FIG. 9 is a block diagram illustrating an exemplary configuration of an adaptive offset filter of FIG. 1.

FIG. 10 is a diagram for describing the parallel processing unit of an adaptive offset filter process.

FIG. 11 is a diagram for describing the parallel processing unit of the adaptive offset filter process.

FIG. 12 is a diagram for describing the parallel processing unit of the adaptive offset filter process.

FIG. 13 is a diagram for describing the parallel processing unit of the adaptive offset filter process.

FIG. 14 is a diagram for describing the parallel processing unit of the adaptive offset filter process.

FIG. 15 is a block diagram illustrating an exemplary configuration of an adaptive loop filter of FIG. 1.

FIG. 16 is a diagram for describing the parallel processing unit of an adaptive loop filter process.

FIG. 17 is a diagram for describing the parallel processing unit of the adaptive loop filter process.

FIG. 18 is a diagram for describing the parallel processing unit of the adaptive loop filter process.

FIG. 19 is a diagram for describing the parallel processing unit of the adaptive loop filter process.

FIG. 20 is a flowchart for describing an encoding process of the encoding apparatus of FIG. 1.

FIG. 21 is a flowchart for describing the encoding process of the encoding apparatus of FIG. 1.

FIG. 22 is a flowchart for describing the details of an inverse quantization parallel process of FIG. 21.

FIG. 23 is a flowchart for describing the details of an inverse orthogonal transform parallel process of FIG. 21.

FIG. 24 is a flowchart for describing the details of an inter prediction parallel process of FIG. 21.

FIG. 25 is a flowchart for describing the details of an addition parallel process of FIG. 21.

FIG. 26 is a flowchart for describing the details of an intra prediction process of FIG. 21.

FIG. 27 is a flowchart for describing the details of a deblocking filter parallel process of FIG. 21.

FIG. 28 is a flowchart for describing the details of an adaptive offset filter parallel process of FIG. 21.

FIG. 29 is a flowchart for describing the details of an adaptive loop filter parallel process of FIG. 21.

FIG. 30 is a block diagram illustrating an exemplary configuration of the first embodiment of a decoding apparatus to which the present technology is applied.

FIG. 31 is a flowchart for describing a decoding process of the decoding apparatus of FIG. 30.

FIG. 32 is a block diagram illustrating an exemplary configuration of a second embodiment of an encoding apparatus as an image processing apparatus to which the present technology is applied.

FIG. 33 is a block diagram illustrating an exemplary configuration a filter processing unit of FIG. 32.

FIG. 34 is a flowchart for describing the encoding process of the encoding apparatus of FIG. 32.

FIG. 35 is a flowchart for describing the encoding process of the encoding apparatus of FIG. 32.

FIG. 36 is a flowchart for describing the details of an inter parallel process of FIG. 35.

FIG. 37 is a flowchart for describing the details of a filter parallel process of FIG. 35.

FIG. 38 is a block diagram illustrating an exemplary configuration of the second embodiment of a decoding apparatus as the image processing apparatus to which the present technology is applied.

FIG. 39 is a flowchart for describing the decoding process of the decoding apparatus of FIG. 38.

FIG. 40 is a block diagram illustrating an exemplary hardware configuration of a computer.

### MODE FOR CARRYING OUT THE INVENTION

### First Embodiment

Exemplary Configuration of First Embodiment of Encoding Apparatus

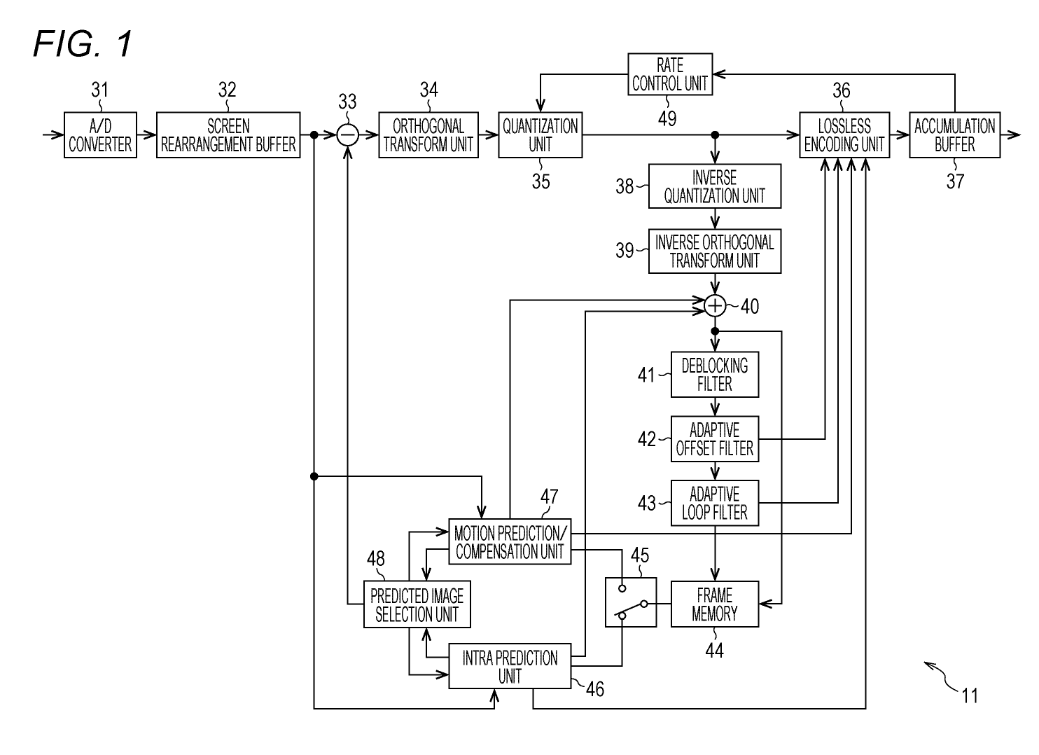

FIG. 1 is a block diagram illustrating an exemplary configuration of a first embodiment of an encoding apparatus as an image processing apparatus to which the present technology is applied.

An encoding apparatus 11 of FIG. 1 includes an A/D converter 31, a screen rearrangement buffer 32, a calculation unit 33, an orthogonal transform unit 34, a quantization unit 35, an lossless encoding unit 36, an accumulation buffer 37, an inverse quantization unit 38, an inverse orthogonal transform unit 39, an addition unit 40, a deblocking filter 41, an adaptive offset filter 42, an adaptive loop filter 43, a frame memory 44, a switch 45, an intra prediction unit 46, a motion prediction/compensation unit 47, a predicted image selection unit 48, and a rate control unit 49. The encoding apparatus 11 encodes an image by a system in conformity to an HEVC system.

Specifically, the A/D converter 31 of the encoding apparatus 11 performs an A/D conversion on the image of a frame unit input as an input signal from the outside, and outputs and stores the converted signal with respect to the screen rearrangement buffer 32. The screen rearrangement buffer 32 rearranges the images of a frame unit stored in a display order into an order for encoding according to a GOP structure, and outputs the images to the calculation unit 33, the intra prediction unit 46, and the motion prediction/compensation unit 47.

The calculation unit 33 performs encoding by calculating a difference between a predicted image supplied from the predicted image selection unit 48 and an encoding target image output from the screen rearrangement buffer 32. Specifically, the calculation unit 33 performs encoding by subtracting the predicted image supplied from the predicted image selection unit 48 from the encoding target image output from the screen rearrangement buffer 32. The calculation unit 33 outputs the image obtained as the result as residual information to the orthogonal transform unit 34. Further, in a case where the predicted image is not supplied from the predicted image selection unit 48, the calculation unit 33 outputs the image itself read out of the screen rearrangement buffer 32 as the residual information to the orthogonal transform unit 34.

The orthogonal transform unit 34 performs an orthogonal transform on the residual information from the calculation unit 33, and supplies the generated orthogonal transform coefficient to the quantization unit 35.

The quantization unit 35 performs the quantization on the orthogonal transform coefficient supplied from the orthogonal transform unit 34, and supplies a coefficient obtained as the result to the lossless encoding unit 36.

The lossless encoding unit 36 acquires information (hereinafter, referred to as “intra prediction mode information”) indicating an optimal intra prediction mode from the intra prediction unit 46. In addition, the lossless encoding unit 36 acquires information (hereinafter, referred to as “inter prediction mode information”) indicating an optimal inter prediction mode, a motion vector, and information for specifying a reference image from the motion prediction/compensation unit 47.

In addition, the lossless encoding unit 36 acquires offset filter information on an offset filter from the adaptive offset filter 42, and acquires a filter coefficient from the adaptive loop filter 43.

The lossless encoding unit 36 performs lossless encoding such as an arithmetic encoding (for example, CABAC (Context-Adaptive Binary Arithmetic Coding), etc.) on the quantized coefficient supplied from the quantization unit 35.

In addition, the lossless encoding unit 36 performs the lossless encoding on the encoding information related to the encoding such as the intra prediction mode information or the inter prediction mode information, the motion vector, and information for specifying the reference image, the offset filter information, and the filter coefficient. The lossless encoding unit 36 supplies the lossless-encoded encoding information and coefficient (syntax) as encoding data to the accumulation buffer 37 in order to accumulate the information and the coefficient therein. Further, the lossless-encoded encoding information may be header information (slice header) of the lossless-encoded coefficient.

The accumulation buffer 37 temporarily stores the encoding data (bit stream) supplied from the lossless encoding unit 36. In addition, the accumulation buffer 37 transmits the encoding data which is stored therein.

In addition, the quantized coefficient output from the quantization unit 35 is also input to the inverse quantization unit 38. The inverse quantization unit 38 performs an inverse quantization in a predetermined processing unit in parallel on the coefficient quantized by the quantization unit 35, and supplies the orthogonal transform coefficient obtained as the result to the inverse orthogonal transform unit 39.

The inverse orthogonal transform unit 39 performs an inverse orthogonal transform in the predetermined processing unit in parallel on the orthogonal transform coefficient supplied from the inverse quantization unit 38, and supplies the residual information obtained as the result to the addition unit 40.

The addition unit 40 serves as a decoding unit, and locally performs the decoding by performing an addition process which adds the predicted image supplied from the motion prediction/compensation unit 47 and the residual information supplied from the inverse orthogonal transform unit 39 in the predetermined processing unit in parallel. The addition unit 40 supplies the locally-decoded image obtained as the result to the frame memory 44. In addition, the addition unit 40 locally performs the decoding by performing the addition process which adds the predicted image supplied from the intra prediction unit 46 and the residual information in a PU (Prediction Unit). The addition unit 40 supplies the locally-decoded image of the PU obtained as the result to the frame memory 44. Furthermore, the addition unit 40 supplies the completely-decoded image in a unit of picture to the deblocking filter 41.

The deblocking filter 41 performs a deblocking filter process of eliminating block deformation in the predetermined processing unit in parallel on the image supplied from the addition unit 40, and supplies the image obtained as the result to the adaptive offset filter 42.

The adaptive offset filter 42 performs an adaptive offset filter (SAO (Sample adaptive offset)) process of mainly eliminating ringing for each LCU (Largest Coding Unit) in the predetermined processing unit in parallel on the image subjected to the deblocking filter process by the deblocking filter 41. The adaptive offset filter 42 supplies the offset filter information which is information on an adaptive offset filter process of each LCU to the lossless encoding unit 36.

The adaptive loop filter 43, for example, is configured by a two-dimensional Wiener filter. The adaptive loop filter 43 performs an adaptive loop filter (ALF (Adaptive Loop Filter)) process for each LCU in the predetermined processing unit in parallel on the image which is subjected to the adaptive offset filter process and supplied from the adaptive offset filter 42. The adaptive loop filter 43 supplies the filter coefficient used in the adaptive loop filter process of each LCU to the lossless encoding unit 36.

The frame memory 44 accumulates the image supplied from the adaptive loop filter 43 and the image supplied from the addition unit 40. The image which is supplied from the adaptive loop filter 43 and accumulated in the frame memory 44 is output as the reference image to the motion prediction/compensation unit 47 through the switch 45. In addition, the image which is supplied from the addition unit 40 and accumulated in the frame memory 44 is output as the reference image to the intra prediction unit 46 through the switch 45.

The intra prediction unit 46 performs an intra prediction process on all the intra prediction modes as candidates in the PU using the reference image which is read out of the frame memory 44 through the switch 45.

In addition, the intra prediction unit 46 calculates cost function values (to be described in detail below) of all the intra prediction modes as the candidates for each PU based on the image read out of the screen rearrangement buffer 32 and the predicted image generated as the result of the intra prediction process. Then, the intra prediction unit 46 determines the intra prediction mode having a minimized cost function value as the optimal intra prediction mode for each PU.

The intra prediction unit 46 supplies the predicted image generated in the optimal intra prediction mode and the corresponding cost function value for each PU to the predicted image selection unit 48.

Further, the cost function value may be a RD (Rate Distortion) cost. For example, the cost function value is calculated based on any one of a High Complexity mode and a Low Complexity mode so as to be determined by JM (Joint Model) as reference software in the H.264/AVC system. Further, the reference software in the H.264/AVC system is disclosed to the public in http://iphome.hhi.de/suehring/tml/index.htm.

Specifically, in a case where the High Complexity mode is employed as a calculation method of the cost function value, all the prediction modes as the candidates are temporarily subjected to the decoding, and the cost function value expressed by the following equation (1) is calculated for each prediction mode.

Cost (Mode)=D+λ·R (1)

Herein, D is a difference (distortion) between the original image and the decoded image, R is the amount of generated codes including the coefficient of the orthogonal transform, and λ is a Lagrange undetermined multiplier given as a function of a quantization parameter QP.

On the other hand, in a case where the Low Complexity mode is employed as a calculation method of the cost function value, the predicted image is generated and the amount of codes of the encoding information is calculated for all the prediction modes as the candidates, and a cost function expressed by the following equation (2) is calculated for each prediction mode.

Cost(Mode)=D+QPtoQuant(QP)·Header_Bit (2)

Herein, D is a difference (distortion) between the original image and the predicted image, Header_Bit is the amount of codes of the encoding information, and QPtoQuant is a function given as a function of the quantization parameter QP.

In the Low Complexity mode, there is only need to generate the predicted image for all the prediction modes, and also the decoded image is not necessarily generated, so that the amount of computation may be reduced.

In a case where the selection of the predicted image generated in the optimal intra prediction mode of a predetermined PU is notified from the predicted image selection unit 48, the intra prediction unit 46 supplies optimal intra prediction mode information of the PU to the lossless encoding unit 36. In addition, the intra prediction unit 46 performs the intra prediction process of the optimal intra prediction mode in the PU with respect to each PU to which the selection of the predicted image generated in the optimal intra prediction mode is notified from the predicted image selection unit 48. The intra prediction unit 46 supplies the predicted image of each PU obtained as the result to the addition unit 40.

The motion prediction/compensation unit 47 performs a motion prediction/compensation process of all the inter prediction modes as the candidates. Specifically, the motion prediction/compensation unit 47 detects the motion vectors of all the inter prediction modes as the candidates for each PU based on the image supplied from the screen rearrangement buffer 32 and the reference image read from the frame memory 44 through the switch 45. Then, the motion prediction/compensation unit 47 performs the compensation process on the reference image for each PU based on the motion vector, and generates the predicted image.

At this time, the motion prediction/compensation unit 47 calculates the cost function values of all the inter prediction modes as the candidates for each PU based on the image supplied from the screen rearrangement buffer 32 and the predicted image, and determines the inter prediction mode having a minimized cost function value as the optimal inter prediction mode. Then, the motion prediction/compensation unit 47 supplies the cost function value of the optimal inter prediction mode and the corresponding predicted image for each PU to the predicted image selection unit 48.

In a case where the selection of the predicted image generated in the optimal inter prediction mode is notified from the predicted image selection unit 48, the motion prediction/compensation unit 47 outputs the inter prediction mode information, the corresponding motion vector, and the information for specifying the reference image to the lossless encoding unit 36. In addition, the motion prediction/compensation unit 47 performs the compensation process of the optimal inter prediction mode on the reference image specified by the information for specifying the reference image based on the corresponding motion vector in the predetermined processing unit in parallel for each PU to which the selection of the predicted image generated in the optimal inter prediction mode is notified from the predicted image selection unit 48. The motion prediction/compensation unit 47 supplies the predicted image obtained as the result in a picture unit to the addition unit 40.

The predicted image selection unit 48 determines a mode having a smaller cost function value in the optimal intra prediction mode and the optimal inter prediction mode as an optimal prediction mode based on the cost function value supplied from the intra prediction unit 46 and the motion prediction/compensation unit 47. Then, the predicted image selection unit 48 supplies the predicted image of the optimal prediction mode to the calculation unit 33. In addition, the predicted image selection unit 48 notifies the selection of the predicted image of the optimal prediction mode to the intra prediction unit 46 or the motion prediction/compensation unit 47.

The rate control unit 49 controls a rate of the quantization operated by the quantization unit 35 based on the encoding data accumulated in the accumulation buffer 37 such that overflow or underfloor does not occur.

Further, in a case where the encoding apparatus 11 performs the encoding according to the HEVC system, the adaptive loop filter 43 is not provided.

<Description of LCU>

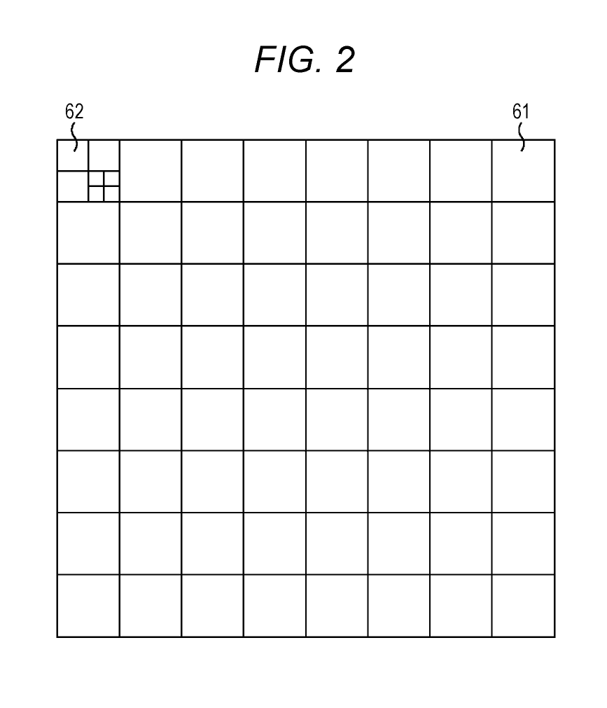

FIG. 2 is a diagram for describing an LCU which is a maximum coding unit in the HEVC system.

As illustrated in FIG. 2, in the HEVC system, a fixed size of LCU (Largest Coding Unit) 61 which includes an SPS (Sequence Parameter Set) is defined as a maximum coding unit. In the example of FIG. 2, a picture is composed of 8×8 LCUs 61. The LCU is further recursively divided in a quadtree division manner, and can make a CU 62 as the coding unit. The CU 62 is divided into the PUs which are units in the intra prediction or the inter prediction, or divided into transform units (TUs) which are units in the orthogonal transform. Further, in the following, a boundary of the LCU 61 is referred to as an LCU boundary.

<Parallel Processing Unit in Inverse Quantization, Inverse Orthogonal Transform, Addition Process, and Compensation Process>

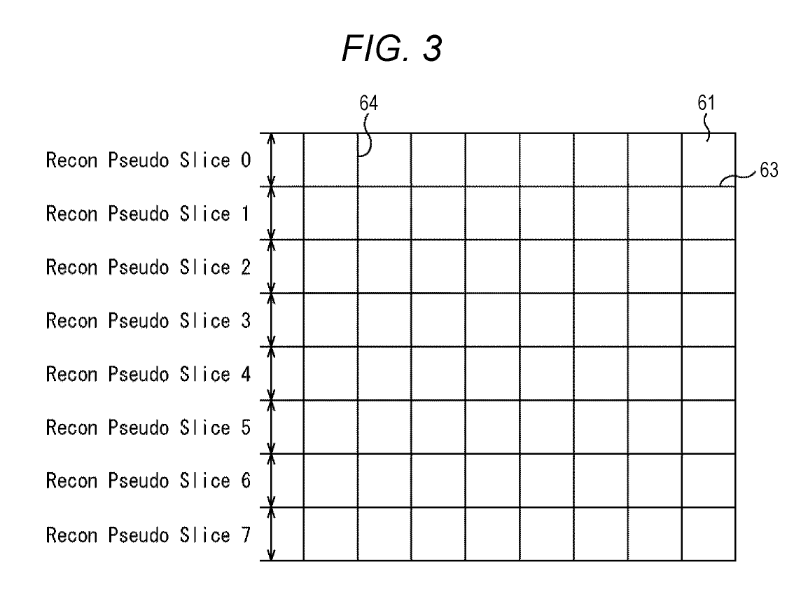

FIG. 3 is a diagram illustrating an example of a parallel processing unit in the inverse quantization, the inverse orthogonal transform, the addition process, and the compensation process.

The inverse quantization, the inverse orthogonal transform, the addition process, and the compensation process can be independently performed in the LCU unit. In the encoding apparatus 11, regardless of the setting of slices and tiles, the inverse quantization, the inverse orthogonal transform, the addition process, and the compensation process are performed in parallel in a unit of Recon Pseudo Slice including one or more LCUs 61.

In the example of FIG. 3, the picture is composed of 8×8 LCUs 61, the Recon Pseudo Slice unit is composed of one row of LCUs 61. Therefore, the picture is composed of 8 Recon Pseudo Slice units.

Further, the Recon Pseudo Slice unit is not limited to the above configuration, and for example, may be composed of one or more columns of LCUs. In other words, the picture is not divided into the Recon Pseudo Slices in LCU boundaries 63 which are arranged in the vertical direction extending in the horizontal direction, but may be divided into the Recon Pseudo Slices in LCU boundaries 64 which are arranged in the horizontal direction extending in the vertical direction.

<Exemplary Configuration of Deblocking Filter>

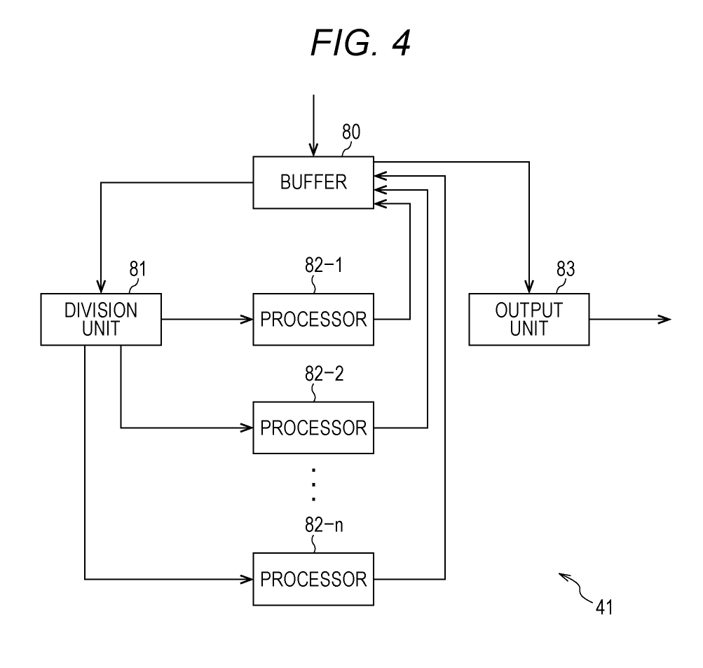

FIG. 4 is a block diagram illustrating an exemplary configuration of the deblocking filter 41 of FIG. 1.

The deblocking filter 41 of FIG. 4 includes a buffer 80, a division unit 81, processors 82-1 to 82-n, and an output unit 83.

The buffer 80 of the deblocking filter 41 stores the completely decoded image supplied from the addition unit 40 of FIG. 1 in a picture unit. In addition, the buffer 80 updates the decoded image with the images which are supplied from the processors 82-1 to 82-n and subjected to the deblocking filter process in the predetermined processing unit.

The division unit 81 divides the image stored in the buffer 80 of a picture unit into n×m (n is an integer of 2 or more, and m is an integer of 1 or more) predetermined processing units. The division unit 81 supplies the images in the n×m divided predetermined processing units to the processors 82-1 to 82-n by m pieces.

Each of the processors 82-1 to 82-n performs the deblocking filter process on the image supplied from the division unit 81 of the predetermined processing unit, and supplies the image obtained as the result to the buffer 80.

The output unit 83 supplies the adaptive offset filter 42 of FIG. 1 with the image which is stored in the buffer 80 and subjected to the deblocking filter process in a picture unit.

<Example of Parallel Processing Unit of Deblocking Filter Process>

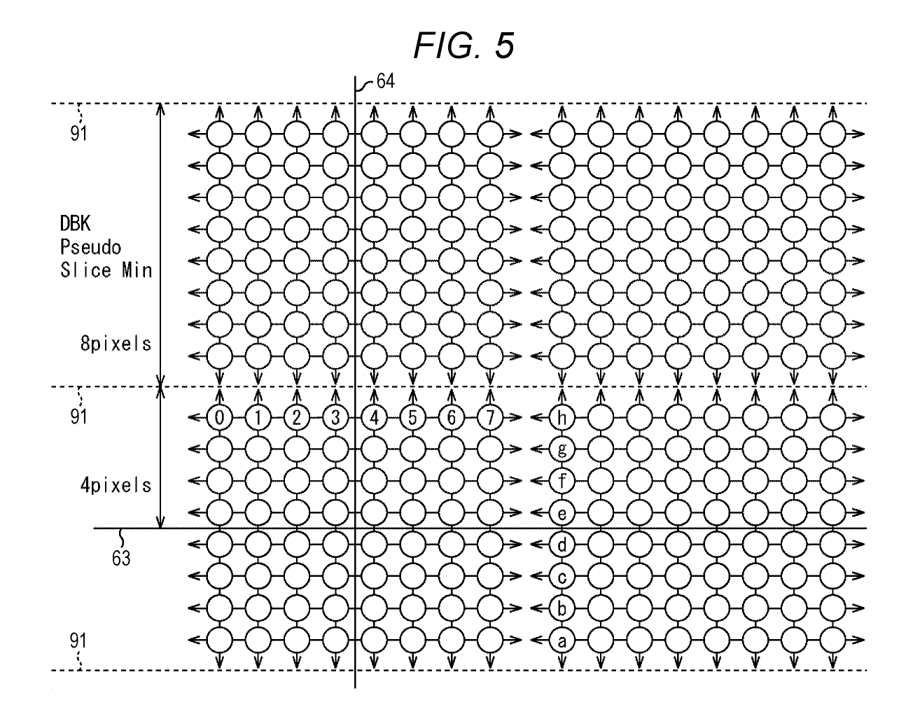

FIGS. 5 to 8 are diagrams for describing the parallel processing unit of the deblocking filter process on a luminance component (luma) of the image.

Circles in FIG. 5 represent pixels.

As illustrated in FIG. 5, in the deblocking filter process of the HEVC system, first the pixels horizontally arranged in the entire picture are subjected to the deblocking filter process in the horizontal direction, and then the pixels vertically arranged in the entire picture are subjected to the deblocking filter process in the vertical direction.

Herein, in the deblocking filter process of the horizontal direction, the pixel values of up to three pixels horizontally adjacent to the boundary are rewritten using pixel values of up to four pixels (for example, the circular pixels denoted with 0 to 7 in FIG. 5) horizontally adjacent to the boundary at every eight pixels in the right direction from the LCU boundary 64 extending in the vertical direction. In addition, in the deblocking filter process of the vertical direction, the pixel values of up to three pixels vertically adjacent to the boundary are rewritten using the pixel values of up to four pixels (for example, the circular pixels denoted with a to h in FIG. 5) vertically adjacent to the boundary at every eight pixels in the downward direction from the LCU boundary 63 extending in the horizontal direction.

Therefore, the boundary De-blocking Pseudo boundary 91 vertically extending in the horizontal direction of a minimum value DBK Pseudo Slice Min of a unit DBK Pseudo Slice in which the deblocking filter process can be independently performed without using another unit DBK Pseudo Slice is located at a position upward by four pixels from the LCU boundary 63 horizontally extending, and a position upward by eight pixels from that position.

Accordingly, the unit DBK Pseudo Slice (hereinafter, referred to as a “parallel processing unit DBK Pseudo Slice”) which is the parallel processing unit of the deblocking filter process on the luminance component of the image becomes a unit which has the boundary De-blocking Pseudo boundary 91 at every multiple of eight pixels as the boundary.

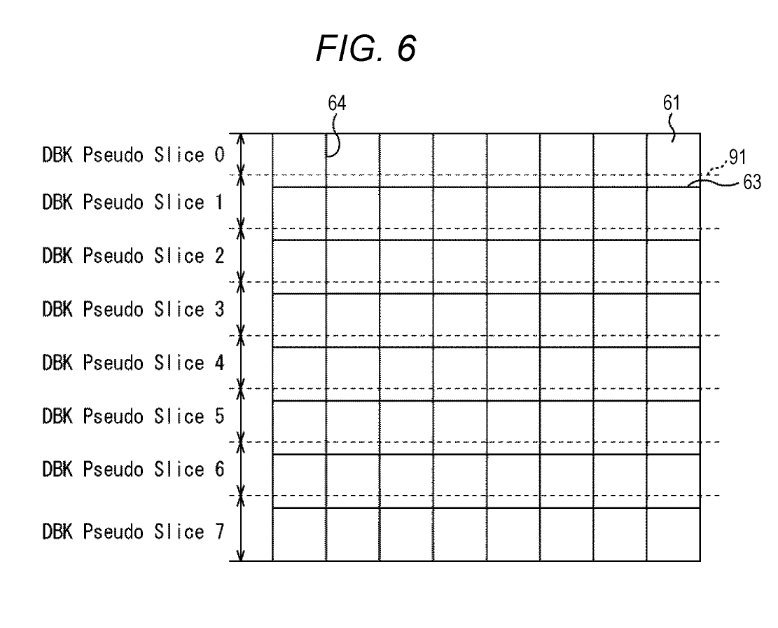

For example, as illustrated in FIG. 6, the parallel processing unit DBK Pseudo Slice of the deblocking filter process on the luminance component of the image can be a unit which has the boundary De-blocking Pseudo boundary 91 positioned upward by four pixels from the LCU boundary 63 as the boundary. In this case, the upper boundary De-blocking Pseudo boundary 91 of an upper parallel processing unit DBK Pseudo Slice and the lower boundary De-blocking Pseudo boundary 91 of a lower parallel processing unit DBK Pseudo Slice are the LCU boundary 63.

In this case, as illustrated in FIG. 6, when the picture is composed of 8×8 LCUs 61, the picture comes to be composed of 8 DBK Pseudo Slices.

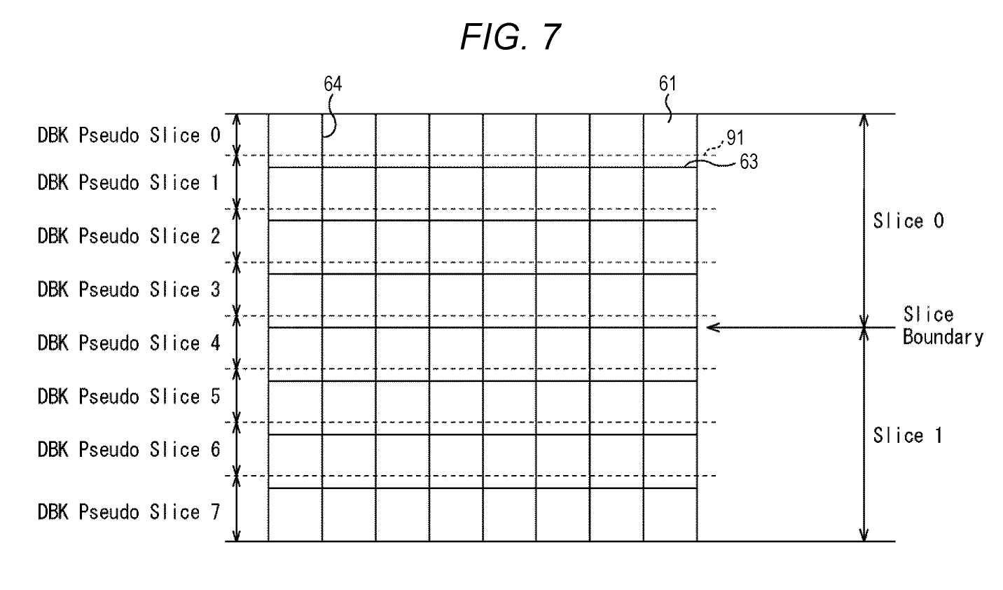

In the case of FIG. 6, the slices and the tiles are not set, but as illustrated in FIG. 7, the parallel processing unit DBK Pseudo Slice is set regardless of the slices even in a case where the slices are set. Even in a case where the tiles are set, it is the same as the case where the slices are set.

As described above, the encoding apparatus 11 performs the deblocking filter process in parallel in the parallel processing unit DBK Pseudo Slice regardless of the setting of the slices and the tiles.

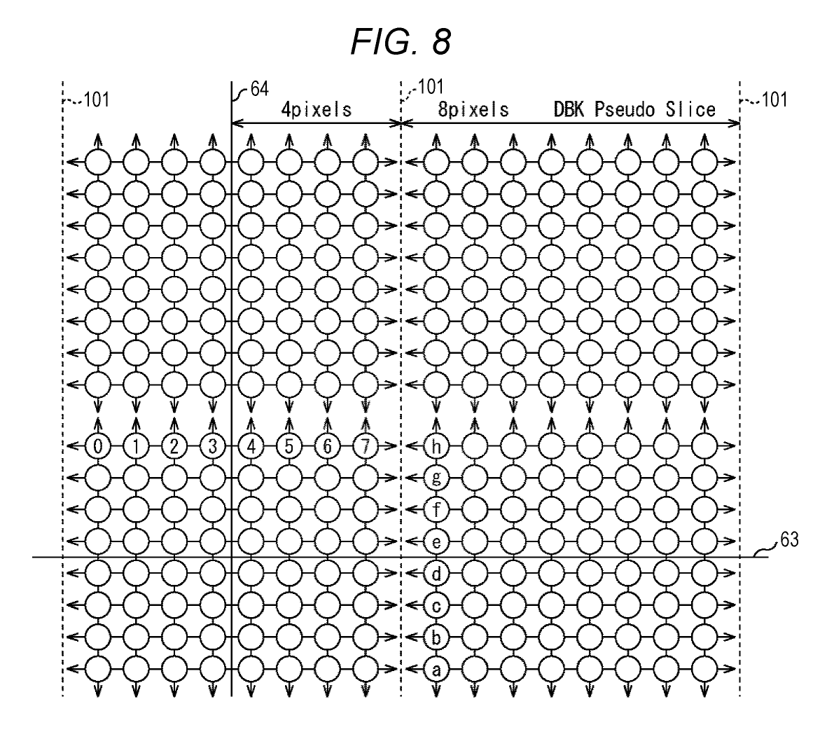

Further, in the examples of FIGS. 5 to 7, the boundary De-blocking Pseudo boundary 91 extending in the horizontal direction of a minimum unit DBK Pseudo Slice Min is set to the boundary of the parallel processing unit DBK Pseudo Slice, but as illustrated in FIG. 8, a boundary De-blocking Pseudo boundary 101 which is arranged in the horizontal direction and extended in the vertical direction of the minimum unit DBK Pseudo Slice Min may be set to the boundary of the parallel processing unit DBK Pseudo Slice.

Specifically, as illustrated in FIG. 8, the boundary De-blocking Pseudo boundary 101 is located at a position on the right side by four pixels from the LCU boundary 64 vertically extending and a position on the right side by eight pixels from that position. Therefore, the parallel processing unit DBK Pseudo Slice becomes a unit which has the boundary De-blocking Pseudo boundary 101 at every multiple of eight pixels as the boundary.

Further, in FIGS. 5 to 8, the description has been made about the parallel processing unit DBK Pseudo Slice of the deblocking filter process on the luminance component of the image, but the same configuration is also applied to the parallel processing unit DBK Pseudo Slice of the deblocking filter process on a color component (chroma).

For example, in a case where the image is YUV422, the boundary De-blocking Pseudo boundary extending in the horizontal direction of the minimum unit DBK Pseudo Slice Min of the color component is equal to the boundary De-blocking Pseudo boundary 91 of the luminance component illustrated in FIG. 5. In addition, the boundary De-blocking Pseudo boundary extending in the vertical direction of the minimum unit DBK Pseudo Slice Min of the color component is located at a position on the right side by two pixels from the LCU boundary 64 extending in the vertical direction and a position on the right side by four pixels from that position. Therefore, the parallel processing unit DBK Pseudo Slice parallel to the horizontal direction of the deblocking filter process on the color component of the image becomes a unit which has the boundary De-blocking Pseudo boundary at every multiple of four pixels as the boundary.

On the other hand, in a case where the image is YUV420, the boundary De-blocking Pseudo boundary extending in the horizontal direction of the minimum unit DBK Pseudo Slice Min of the color component is located at a position upward by two pixels from the LCU boundary 63 extending in the horizontal direction and a position upward by four pixels from that position. In addition, the boundary De-blocking Pseudo boundary extending in the vertical direction of the minimum unit DBK Pseudo Slice Min of the color component is located at a position on the right side by two pixels from the LCU boundary 64 extending in the vertical direction and a position on the right side by four pixels from that position.

Therefore, the parallel processing unit DBK Pseudo Slice of the deblocking filter process on the color component of the image becomes a unit which has the boundary De-blocking Pseudo boundary at every multiple of four pixels as the boundary.

In addition, in a case where the image is YUV444, the boundary De-blocking Pseudo boundaries extending in the horizontal direction and the vertical direction of the minimum unit DBK Pseudo Slice Min of the color component are equal to the boundary De-blocking Pseudo boundary 91 of the luminance component of FIG. 5 and the boundary De-blocking Pseudo boundary 101 of the luminance component of FIG. 8, respectively.

<Exemplary Configuration of Adaptive Offset Filter>

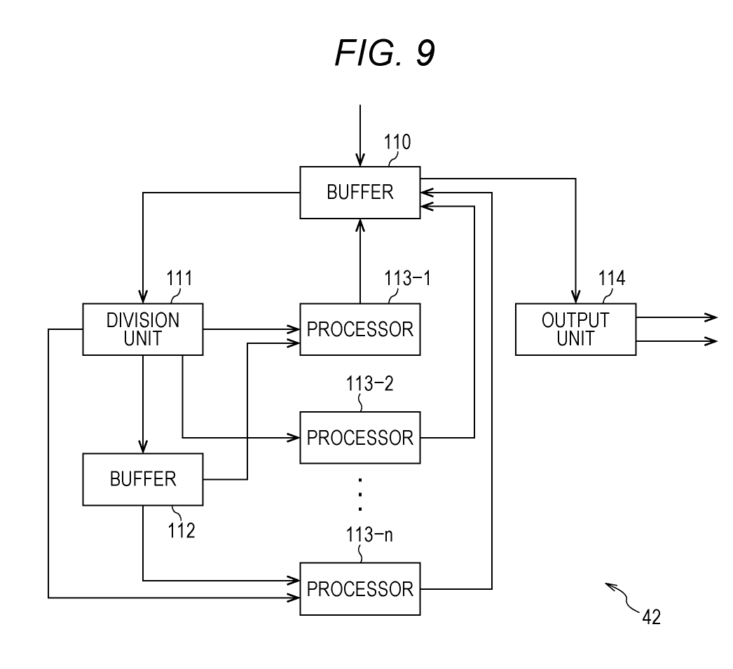

FIG. 9 is a block diagram illustrating an exemplary configuration of the adaptive offset filter 42 of FIG. 1.

The adaptive offset filter 42 of FIG. 9 includes a buffer 110, a division unit 111, a buffer 112, processors 113-1 to 113-n, and an output unit 114.

The buffer 110 of the adaptive offset filter 42 stores the image which is supplied from the deblocking filter 41 of FIG. 1 and subjected to the deblocking filter process in a picture unit. The buffer 110 updates the image subjected to the deblocking filter process with the images which are supplied from the processors 113-1 to 113-n and subjected to the adaptive offset filter process. In addition, the buffer 110 stores the offset filter information of the LCUs supplied from the processors 113-1 to 113-n in correspondence with the image subjected to the adaptive offset filter process.

The division unit 111 divides the image which is stored in the buffer 110 and subjected to the deblocking filter process in a picture unit into n×m predetermined processing units. The division unit 111 supplies the images of the n×m divided predetermined processing units to the processors 113-1 to 113-n by m pieces. In addition, the division unit 111 supplies the pixel values of the pixels in the boundary of the predetermined processing unit among the images of the n×m divided predetermined processing units to the buffer 112, and stores the pixel values therein. The buffer 112 serves as a storage unit, and stores the pixel value supplied from the division unit 111.

Each of the processors 113-1 to 113-n performs the adaptive offset filter process for each LCU on the image of the predetermined processing unit supplied from the division unit 111 using the pixel value stored in the buffer 112. Then, each of the processors 113-1 to 113-n supplies the image subjected to the adaptive offset filter process of each LCU and the offset filter information indicating a type of the corresponding adaptive offset filter process and an offset used in the adaptive offset filter process to the buffer 110.

The output unit 114 supplies the adaptive loop filter 43 of FIG. 1 with the image which is stored in the buffer 110 and subjected to the adaptive offset filter process in a picture unit, and supplies the lossless encoding unit 36 with the offset filter information of each LCU.

<Example of Parallel Processing Unit of Adaptive Offset Filter Process>

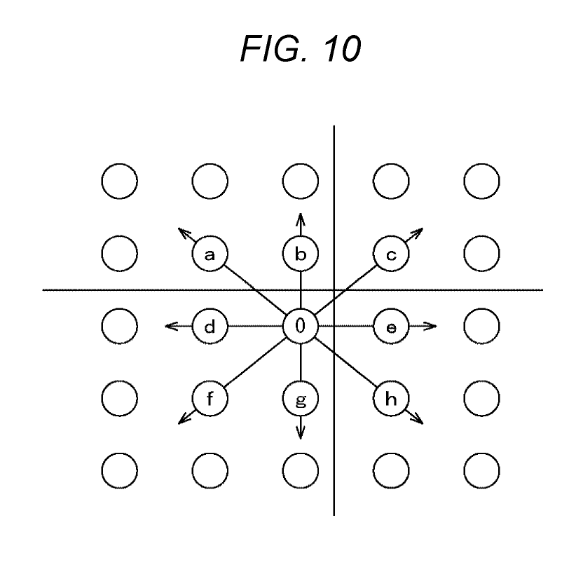

FIGS. 10 to 14 are diagrams for describing the parallel processing unit of the adaptive offset filter process.

Circles in FIG. 10 represent the pixels.

As illustrated in FIG. 10, in the adaptive offset filter process of the HEVC system, total nine pixels including the current pixel and the pixels depicted by the circles tagged with “a” to “h” (the pixels are each disposed around the current pixel) may be used for the current pixel depicted by the circle tagged with “0” in the drawing. Therefore, there is no boundary which cuts off dependency like the boundary De-blocking Pseudo boundary.

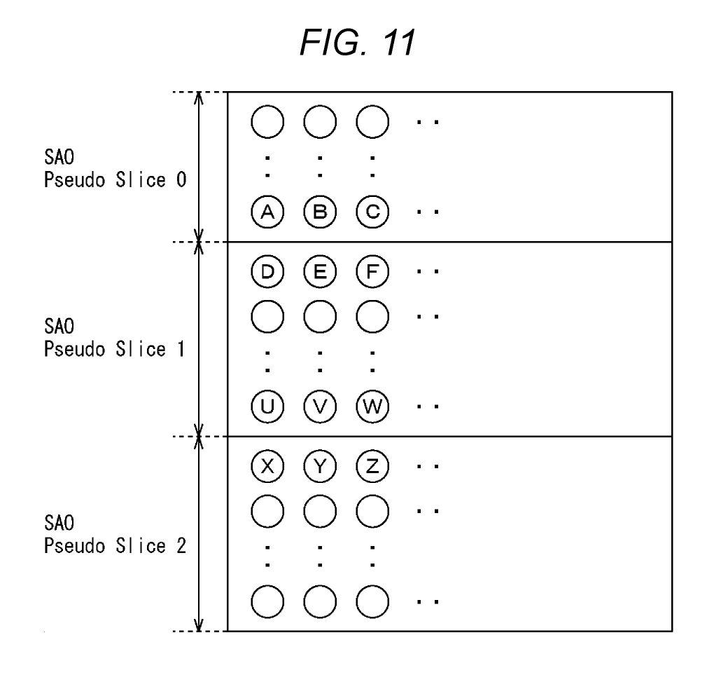

Therefore, as illustrated in FIG. 11, for example, a unit having the boundary in the vertical direction of any pixel as the boundary becomes a parallel processing unit SAO Pseudo Slice of the adaptive offset filter process. In the example of FIG. 11, the picture is divided into three parallel processing units SAO Pseudo Slice.

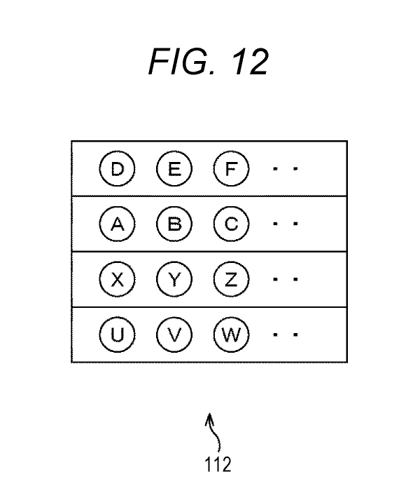

Then, as described with reference to FIG. 10, in the adaptive offset filter process of the HEVC system, since the pixels each disposed around the current pixel may be used for the current pixel, as illustrated in FIG. 12, the division unit 111 stores the pixel value of the pixel in the boundary of the parallel processing unit SAO Pseudo Slice in the buffer 112.

Specifically, as illustrated in FIG. 12, the pixel values of the pixels represented by the circles tagged with “D” to “F” in the uppermost row of the parallel processing unit SAO Pseudo Slice in the center, and the pixel values of the pixels represented by the circles tagged with “A” to “C” in the lowermost row of an upper parallel processing unit SAO Pseudo Slice are stored in the buffer 112. In addition, the pixel values of the pixels represented by the circles tagged with “X” to “Z” in the uppermost row of a lower parallel processing unit SAO Pseudo Slice, and the pixel values of the pixels represented by the circles tagged with “U” to “W” in the lowermost row of the parallel processing unit SAO Pseudo Slice in the center are stored in the buffer 112.

The stored pixels in the uppermost row of the parallel processing unit SAO Pseudo Slice are used as needed at the time of the adaptive offset filter process on the pixels in the lowermost row of the parallel processing unit SAO Pseudo Slice above the subject parallel processing unit SAO Pseudo Slice. In addition, the pixels in the lowermost row of the parallel processing unit SAO Pseudo Slice are used as needed at the time of the adaptive offset filter process on the pixels in the uppermost row of the parallel processing unit SAO Pseudo Slice below the subject parallel processing unit SAO Pseudo Slice.

In this regard, in a case where the pixel values of the pixels in the boundary of the parallel processing unit SAO Pseudo Slice are not stored in the buffer 112, the processors 113-1 to 113-n necessarily read the pixel values from the buffer 110. However, in a case where the processors 113-1 to 113-n asynchronously perform the adaptive offset filter process, the pixel values may be already updated to the pixel values after being subjected to the adaptive offset filter process, so that the adaptive offset filter process may not be accurately performed.

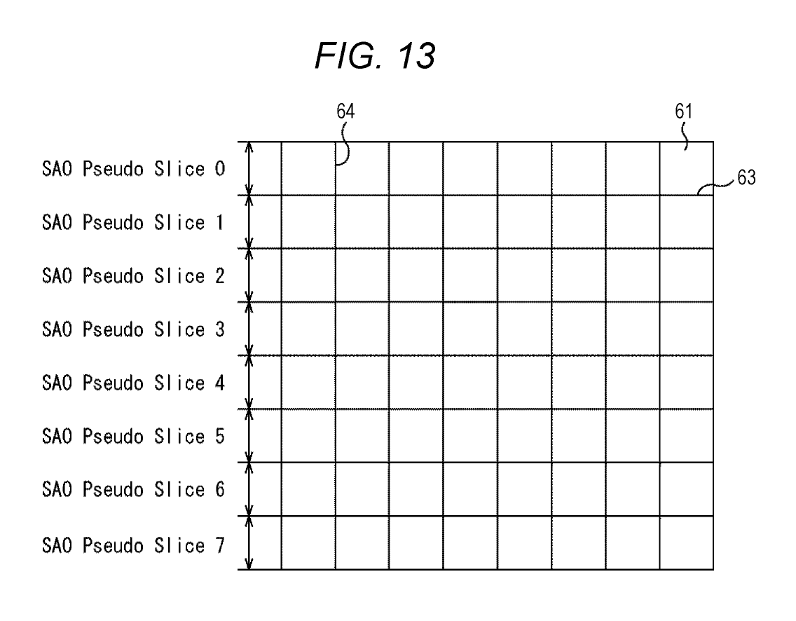

Further, as illustrated in FIG. 13, the boundary of the parallel processing unit SAO Pseudo Slice may be the LCU boundary 63 extending in the horizontal direction. In the example of FIG. 13, since the picture is composed of 8×8 LCUs 61, the picture comes to be composed of eight parallel processing units SAO Pseudo Slice.

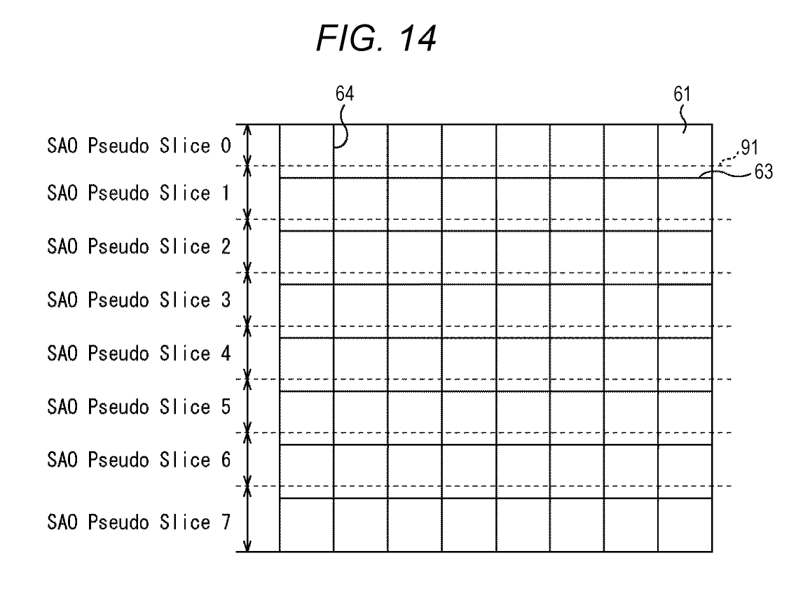

In addition, as illustrated in FIG. 14, the boundary of the parallel processing unit SAO Pseudo Slice may be the boundary De-blocking Pseudo boundary 91 extending in the horizontal direction.

Furthermore, while not illustrated in the drawings, the boundary of the parallel processing unit SAO Pseudo Slice may be a boundary in the horizontal direction of arbitrary pixels. In addition, the boundary of the parallel processing unit SAO Pseudo Slice may be the LCU boundary 64 extending in the vertical direction, or may be the boundary De-blocking Pseudo boundary 101 extending in the vertical direction.

In addition, while not illustrated in the drawings, the parallel processing unit SAO Pseudo Slice may be equal to the parallel processing unit DBK Pseudo Slice.

<Exemplary Configuration of Adaptive Loop Filter>

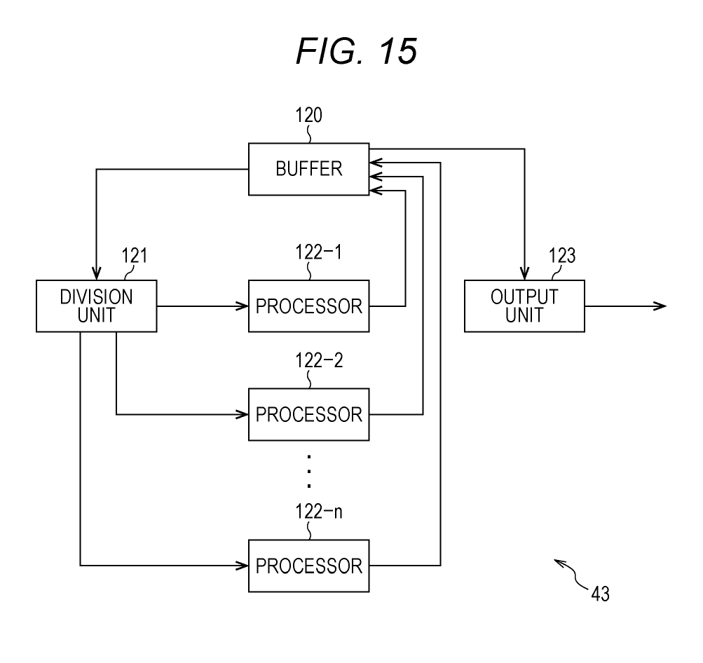

FIG. 15 is a block diagram illustrating an exemplary configuration of the adaptive loop filter 43 of FIG. 1.

The adaptive loop filter 43 of FIG. 15 includes a buffer 120, a division unit 121, processors 122-1 to 122-n, and an output unit 123.

The buffer 120 of the adaptive loop filter 43 stores the image which is supplied from the adaptive offset filter 42 of FIG. 1 and subjected to the adaptive offset filter process in a picture unit. The buffer 120 updates the images subjected to the adaptive offset filter process with the images which are subjected to the adaptive loop filter process and supplied from the processors 122-1 to 122-n. In addition, the buffer 120 stores the filter coefficients of the LCUs supplied from the processors 122-1 to 122-n in correspondence with the images subjected to the adaptive loop filter process.

The division unit 121 divides the image which is stored in the buffer 120 and subjected to the adaptive offset filter process in a picture unit into n×m predetermined processing units. The division unit 121 supplies the images of the n×m divided predetermined processing units to the processors 122-1 to 122-n by m pieces.

Each of the processors 122-1 to 122-n calculates the filter coefficient used in the adaptive loop filter process for each LCU on the image of the predetermined processing unit supplied from the division unit 121, and performs the adaptive loop filter process using the filter coefficient. Then, each of the processors 122-1 to 122-n supplies the image subjected to the adaptive loop filter process of each LCU and the corresponding filter coefficient to the buffer 120.

Further, herein, the adaptive loop filter process is described to be performed for each LCU, but a processing unit of the adaptive loop filter process is not limited to the LCU. However, the processing can be efficiently performed by combining the processing unit of the adaptive offset filter 42 and the processing unit of the adaptive loop filter 43.

The output unit 123 supplies the frame memory 44 of FIG. 1 with the image which is stored in the buffer 120 and subjected to the adaptive loop filter process in a picture unit, and supplies the lossless encoding unit 36 with the filter coefficient of each LCU.

<Example of Parallel Processing Unit of Adaptive Loop Filter Process>

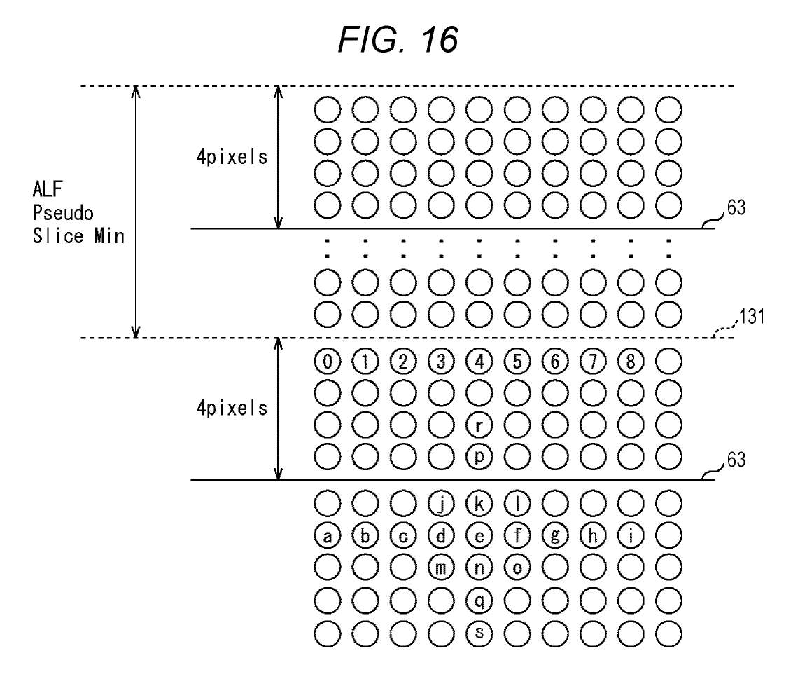

FIGS. 16 to 19 are diagrams for describing the parallel processing unit of the adaptive loop filter process.

Circles in FIG. 16 represent the pixels.

As illustrated in FIG. 16, in the adaptive loop filter process, total 19 pixels obtained from total nine pixels including the current pixel and the pixels depicted by the circles tagged with “a” to “i” in the drawing (the pixels are four pixels in the horizontal direction with the current image as the center), total six pixels depicted by the circles tagged with “r”, “p”, “k”, “n”, “q”, and “s” in the drawing (the pixels are three pixels in the vertical direction with the current image as the center), and total four pixels depicted by the circles tagged with “j”, “l”, “m”, and “o” in the drawing (the pixels are each disposed around the current pixel in the oblique directions) are used for the current pixel depicted by the circle tagged with “e” in the drawing.

However, it is prohibited that 19 pixels are positioned upward by four pixels from the LCU boundary 63 extending in the horizontal direction. For example, in the adaptive loop filter process performed on the pixel depicted by the circle tagged with “4” of FIG. 16 as the current pixel, only the pixels depicted by the circles tagged with “0” to “8” in the drawing are referred to as its vicinity.

Therefore, a boundary ALF Pseudo boundary 131 vertically extending in the horizontal direction of a minimum value ALF Pseudo Slice Min of a unit ALF Pseudo Slice in which the adaptive loop filter process can be independently performed without using another unit ALF Pseudo Slice is located at a position upward by four pixels from the LCU boundary 63 extending in the horizontal direction.

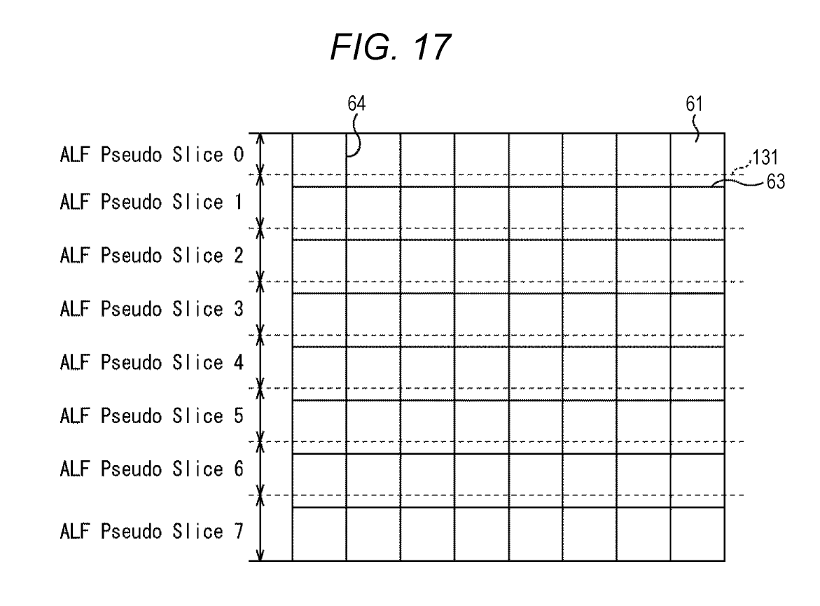

Accordingly, for example, as illustrated in FIG. 17, the unit ALF Pseudo Slice (hereinafter, referred to as a “parallel processing unit ALF Pseudo Slice”) which is the parallel processing unit of the adaptive loop filter process can become a unit which has the boundary ALF Pseudo boundary 131 upward by four pixels from the LCU boundary 63 as the boundary. Further, the upper boundary ALF Pseudo boundary 131 of an upper parallel processing unit ALF Pseudo Slice and the lower boundary ALF Pseudo boundary 131 of a lower parallel processing unit ALF Pseudo Slice are the LCU boundary 63.

In this case, as illustrated in FIG. 17, when the picture is composed of 8×8 LCUs 61, the picture comes to be composed of eight ALF Pseudo Slices. In the case of FIG. 17, the slices and the tiles are not set. However, even in a case where the slices or the tiles are set, the unit ALF Pseudo Slice is set regardless of the slices and the tiles.

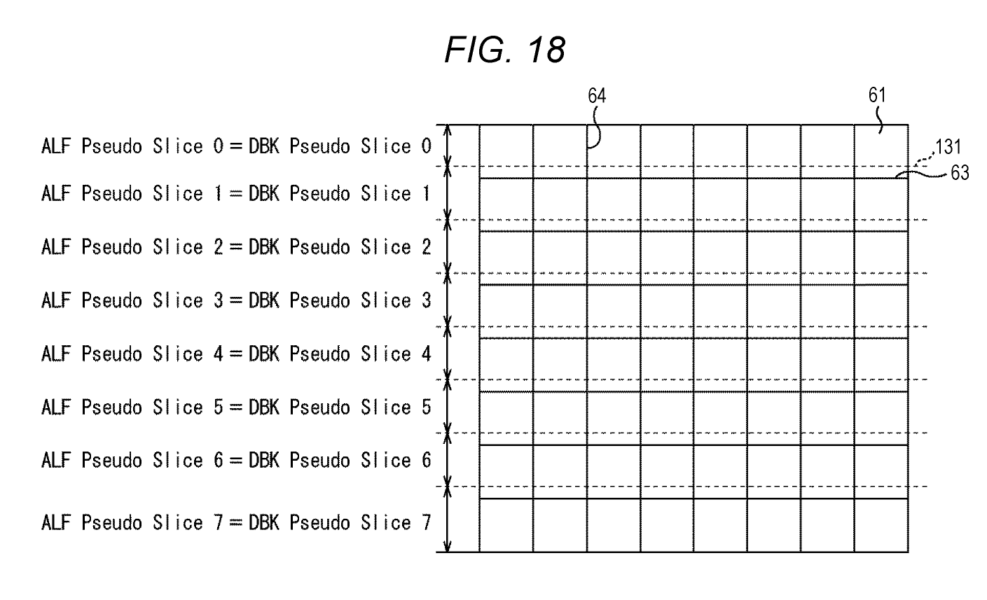

In addition, as described above, the boundary ALF Pseudo boundary 131 extending in the horizontal direction of the minimum value ALF Pseudo Slice Min is located at a position upward by four pixels from the LCU boundary 63 extending in the horizontal direction. Further, the boundary De-blocking Pseudo boundary 91 extending in the horizontal direction of the minimum value DBK Pseudo Slice is located at a position upward by four pixels from the LCU boundary 63 extending in the horizontal direction and a position upward by eight pixels from that position. Therefore, as illustrated in FIG. 18, the parallel processing unit DBK Pseudo Slice can be made equal to the parallel processing unit ALF Pseudo Slice.

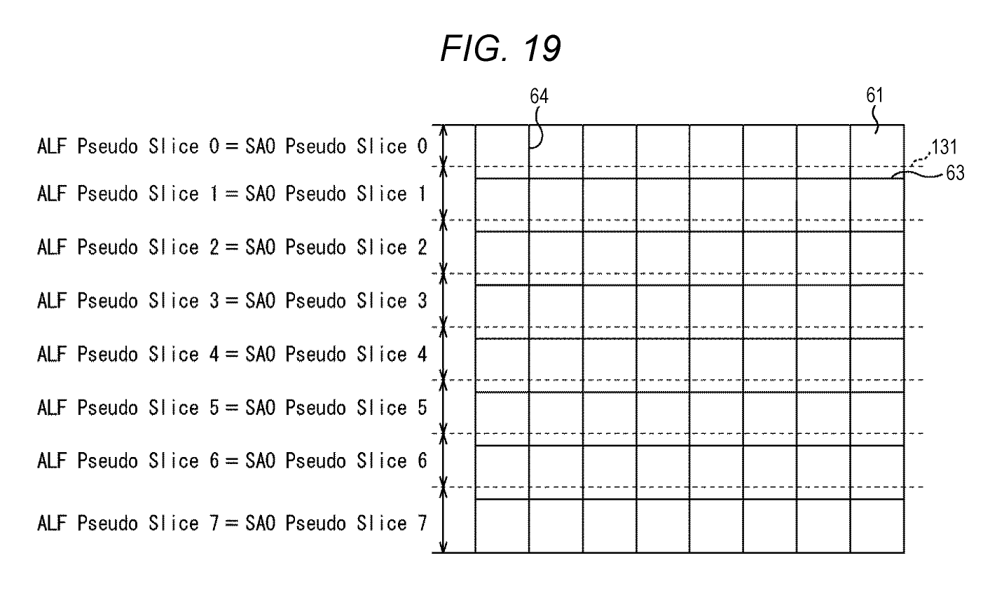

In addition, as described above, the parallel processing unit SAO Pseudo Slice of the adaptive offset filter process can be used as a unit having the boundary in the vertical direction of any pixel as the boundary. Therefore, as illustrated in FIG. 19, the parallel processing unit SAO Pseudo Slice can be made equal to the parallel processing unit ALF Pseudo Slice.

<Description of Process of Encoding Apparatus>

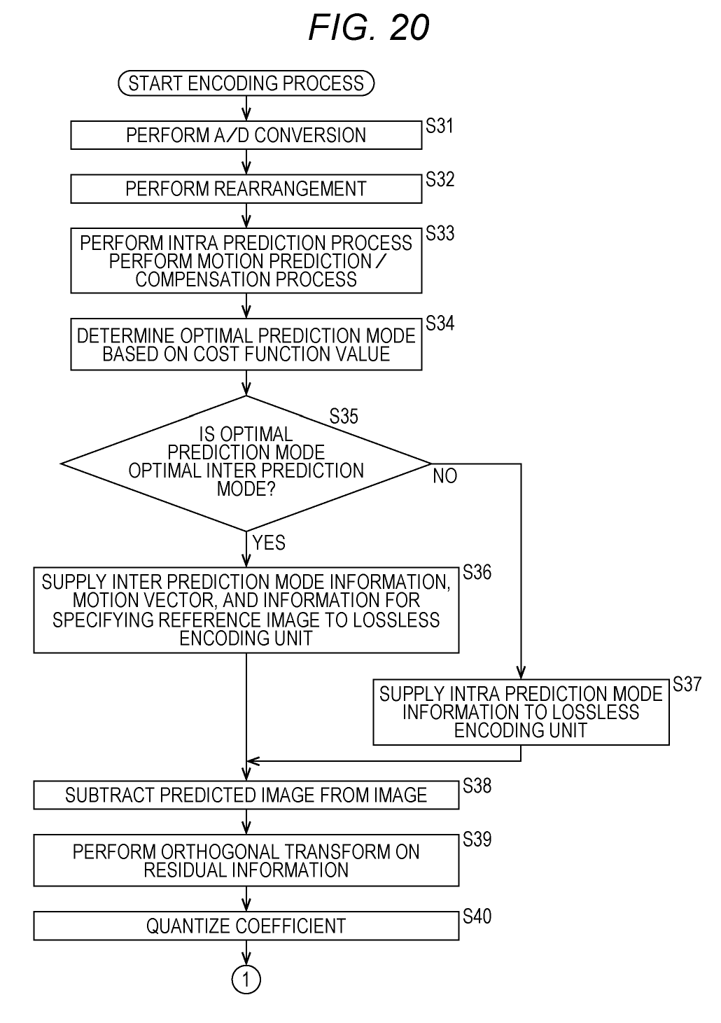

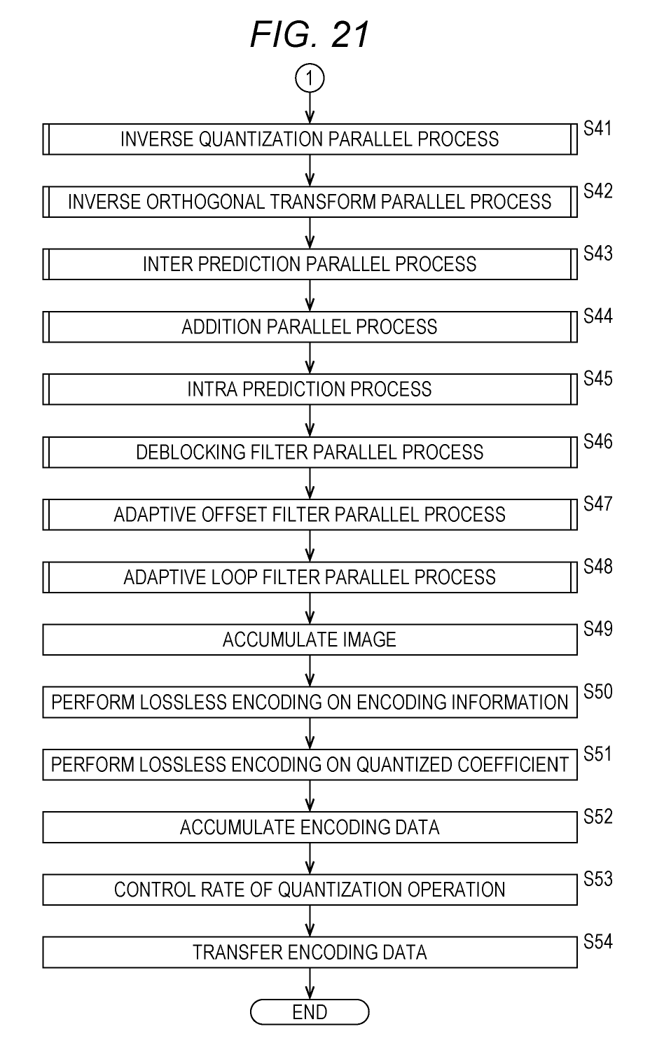

FIGS. 20 and 21 are flowcharts for describing an encoding process of the encoding apparatus 11 of FIG. 1. The encoding process, for example, is performed in a frame unit.

In step S31 of FIG. 20, the A/D converter 31 of the encoding apparatus 11 performs an A/D conversion on the image of a frame unit input as an input signal from the outside, and outputs and stores the converted signal with respect to the screen rearrangement buffer 32.

In step S32, the screen rearrangement buffer 32 rearranges the images of a frame stored in a display order into an order for encoding according to a GOP structure. The screen rearrangement buffer 32 supplies the rearranged images of a frame unit to the calculation unit 33, the intra prediction unit 46, and the motion prediction/compensation unit 47. The subsequent processes of steps S33 to S37 are performed in the PU.

In step S33, the intra prediction unit 46 performs the intra prediction process on all the intra prediction modes as candidates. In addition, the intra prediction unit 46 calculates cost function values of all the intra prediction modes as the candidates based on the image read out of the screen rearrangement buffer 32 and the predicted image generated as the result of the intra prediction process. Then, the intra prediction unit 46 determines the intra prediction mode having a minimized cost function value as the optimal intra prediction mode. The intra prediction unit 46 supplies the predicted image generated in the optimal intra prediction mode and the corresponding cost function value to the predicted image selection unit 48.

In addition, the motion prediction/compensation unit 47 performs a motion prediction/compensation process on all the inter prediction modes as the candidates. In addition, the motion prediction/compensation unit 47 calculates the cost function values of all the inter prediction modes as the candidates based on the image supplied from the screen rearrangement buffer 32 and the predicted image, and determines the inter prediction mode having a minimized cost function value as the optimal inter prediction mode. Then, the motion prediction/compensation unit 47 supplies the cost function value of the optimal inter prediction mode and the corresponding predicted image to the predicted image selection unit 48.

In step S34, the predicted image selection unit 48 determines a mode having a smaller cost function value in the optimal intra prediction mode and the optimal inter prediction mode as an optimal prediction mode based on the cost function value supplied from the intra prediction unit 46 and the motion prediction/compensation unit 47 by the process of step S33. Then, the predicted image selection unit 48 supplies the predicted image of the optimal prediction mode to the calculation unit 33.

In step S35, the predicted image selection unit 48 determines whether the optimal prediction mode is the optimal inter prediction mode. In step S35, in a case where it is determined that the optimal prediction mode is the optimal inter prediction mode, the predicted image selection unit 48 notifies the selection of the predicted image generated in the optimal inter prediction mode to the motion prediction/compensation unit 47.

Then, in step S36, the motion prediction/compensation unit 47 supplies the information for specifying the inter prediction mode information, the motion vector, and the reference image to the lossless encoding unit 36.

On the other hand, in step S35, in a case where the optimal prediction mode is not the optimal inter prediction mode (that is, a case where the optimal prediction mode is the optimal intra prediction mode), the predicted image selection unit 48 notifies the selection of the predicted image generated in the optimal intra prediction mode to the intra prediction unit 46. Then, in step S37, the intra prediction unit 46 supplies the intra prediction mode information to the lossless encoding unit 36, and the process proceeds to step S38.

In step S38, the calculation unit 33 performs encoding by subtracting the predicted image supplied from the predicted image selection unit 48 from the image supplied from the screen rearrangement buffer 32. The calculation unit 33 outputs the image obtained as the result as the residual information to the orthogonal transform unit 34.

In step S39, the orthogonal transform unit 34 performs the orthogonal transform on the residual information from the calculation unit 33, and supplies the orthogonal transform coefficient obtained as the result to the quantization unit 35.

In step S40, the quantization unit 35 performs the quantization on the coefficient supplied from the orthogonal transform unit 34, and supplies the coefficient obtained as the result to the lossless encoding unit 36 and the inverse quantization unit 38.

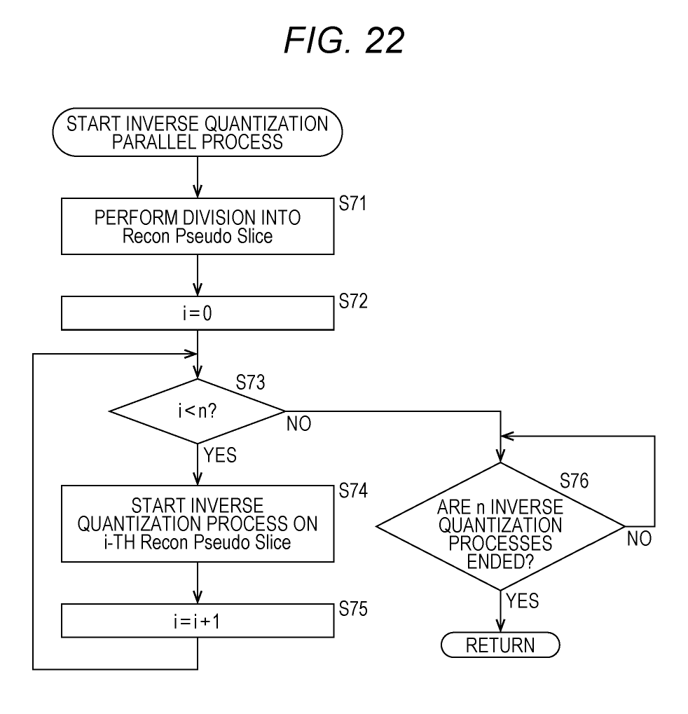

In step S41 of FIG. 21, the inverse quantization unit 38 performs an inverse quantization parallel process in which the inverse quantization is performed in a Recon Pseudo Slice unit in parallel on the quantized coefficient supplied from the quantization unit 35. The details of the inverse quantization parallel process will be described below with reference to FIG. 22.

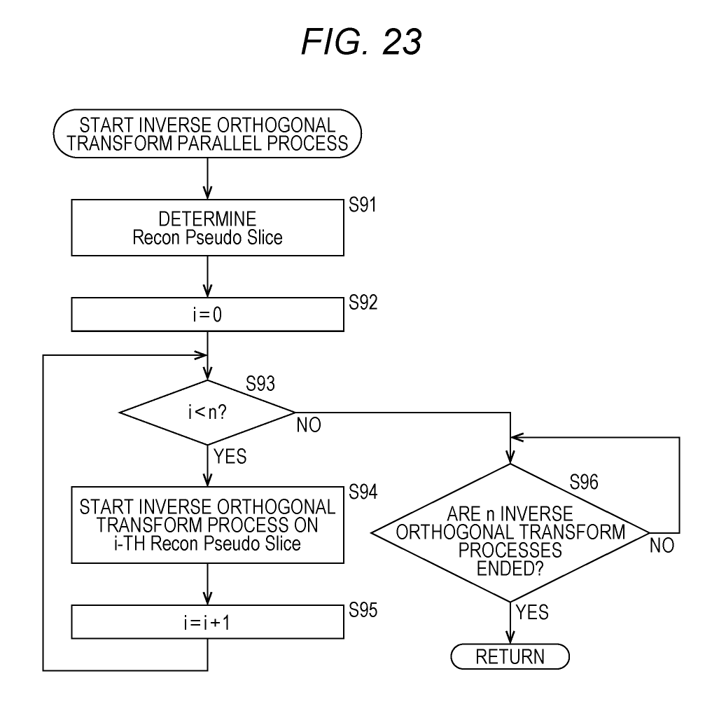

In step S42, the inverse orthogonal transform unit 39 performs an inverse orthogonal transform parallel process in which the inverse orthogonal transform is performed in the Recon Pseudo Slice unit in parallel on the orthogonal transform coefficient supplied from the inverse quantization unit 38. The details of the inverse orthogonal transform parallel process will be described below with reference to FIG. 23.

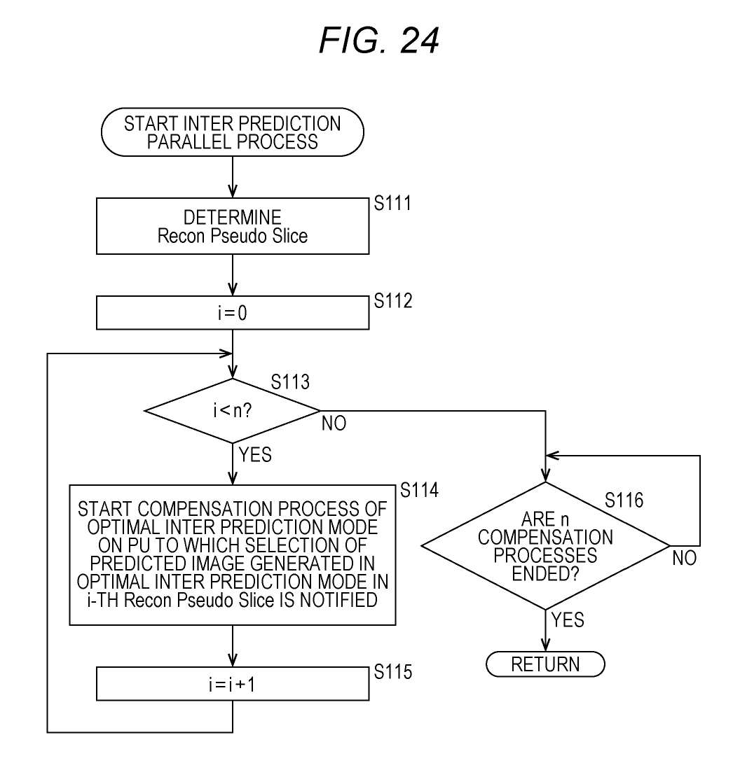

In step S43, the motion prediction/compensation unit 47 performs an inter prediction parallel process in which the compensation process of the optimal inter prediction mode is performed in the Recon Pseudo Slice unit in parallel on the PU to which the selection of the predicted image generated in the optimal inter prediction mode is notified from the predicted image selection unit 48. The details of the inter prediction parallel process will be described below with reference to FIG. 24.

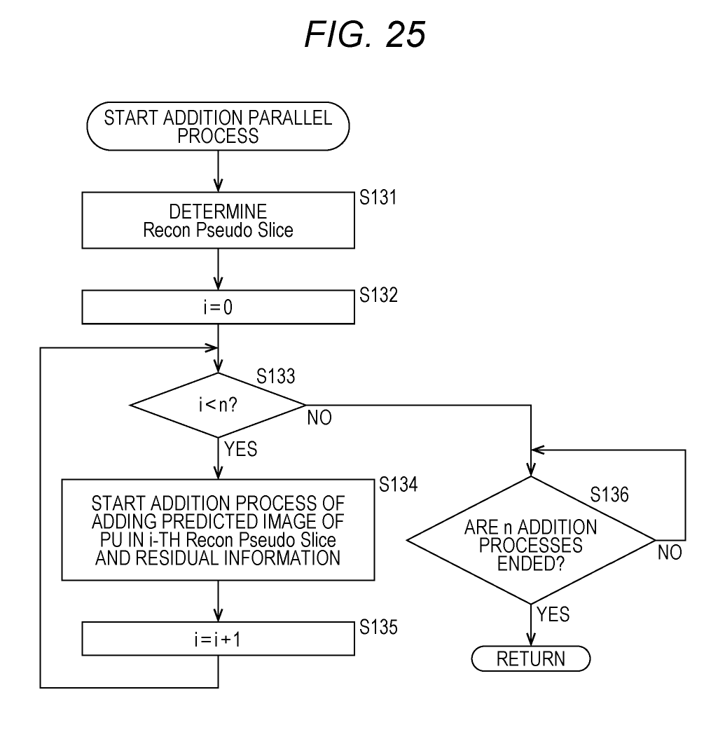

In step S44, the addition unit 40 performs an addition parallel process in which the residual information supplied from the inverse orthogonal transform unit 39 and the predicted image supplied from the motion prediction/compensation unit 47 are added in parallel in the Recon Pseudo Slice unit. The details of the addition parallel process will be described below with reference to FIG. 25.

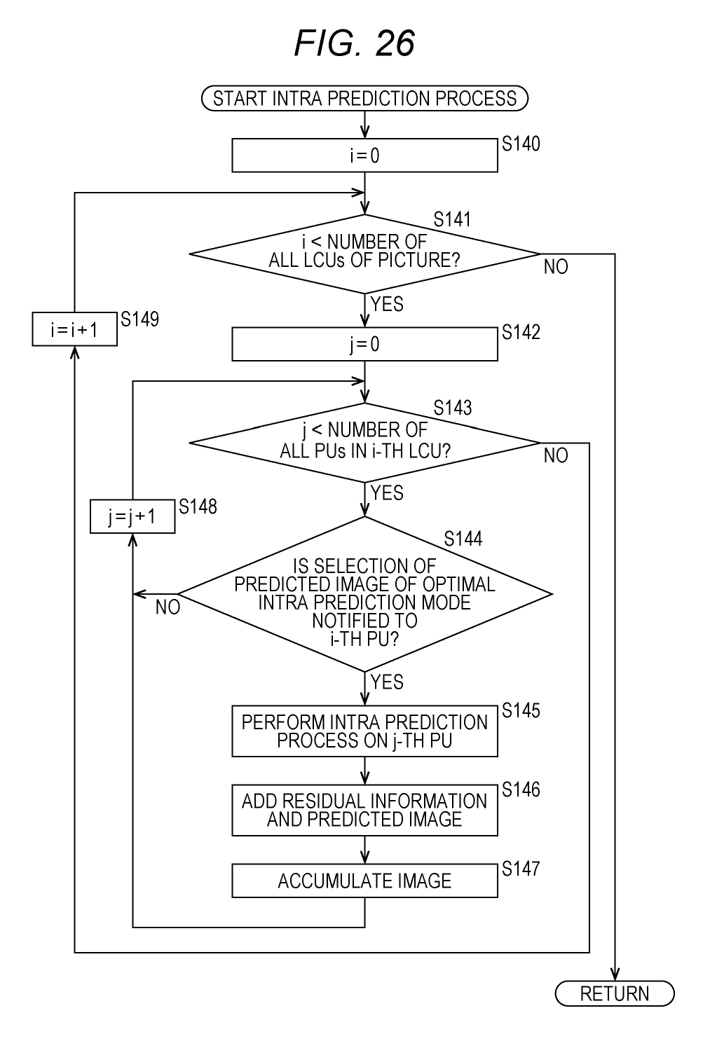

In step S45, the encoding apparatus 11 performs the intra prediction process of the optimal intra prediction mode in the PU to which the selection of the predicted image generated in the optimal intra prediction mode is notified from the predicted image selection unit 48. The details of the intra prediction process will be described below with reference to FIG. 26.

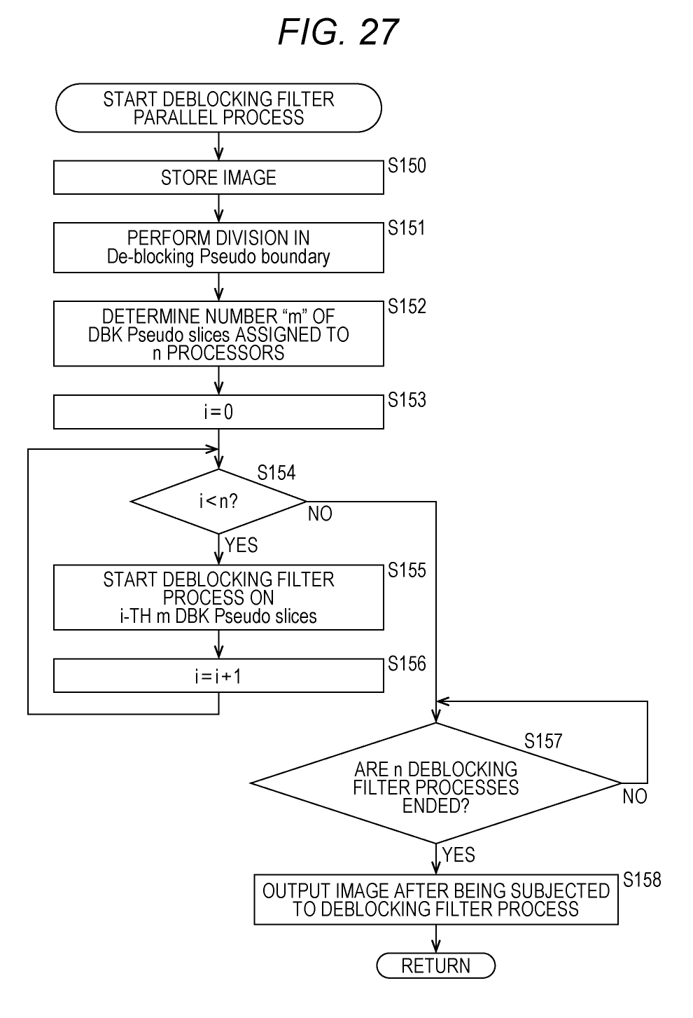

In step S46, the deblocking filter 41 performs a deblocking filter parallel process in which the deblocking filter process is performed in m parallel processing units DBK Pseudo Slice in parallel on the decoded image supplied from the addition unit 40. The deblocking filter parallel process will be described below with reference to FIG. 27.

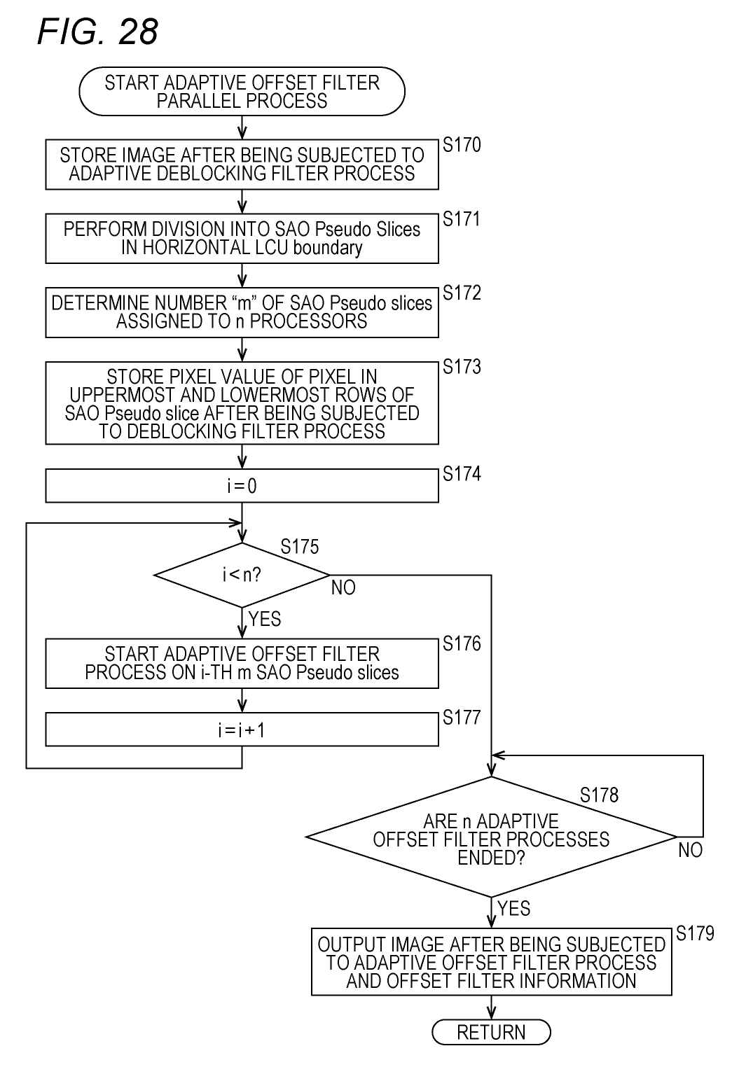

In step S47, the adaptive offset filter 42 performs an adaptive offset filter parallel process in which the adaptive offset filter process is performed in m parallel processing units SAO Pseudo Slice in parallel for each LCU on the image supplied from the deblocking filter 41. The details of the adaptive offset filter parallel process will be described below with reference to FIG. 28.

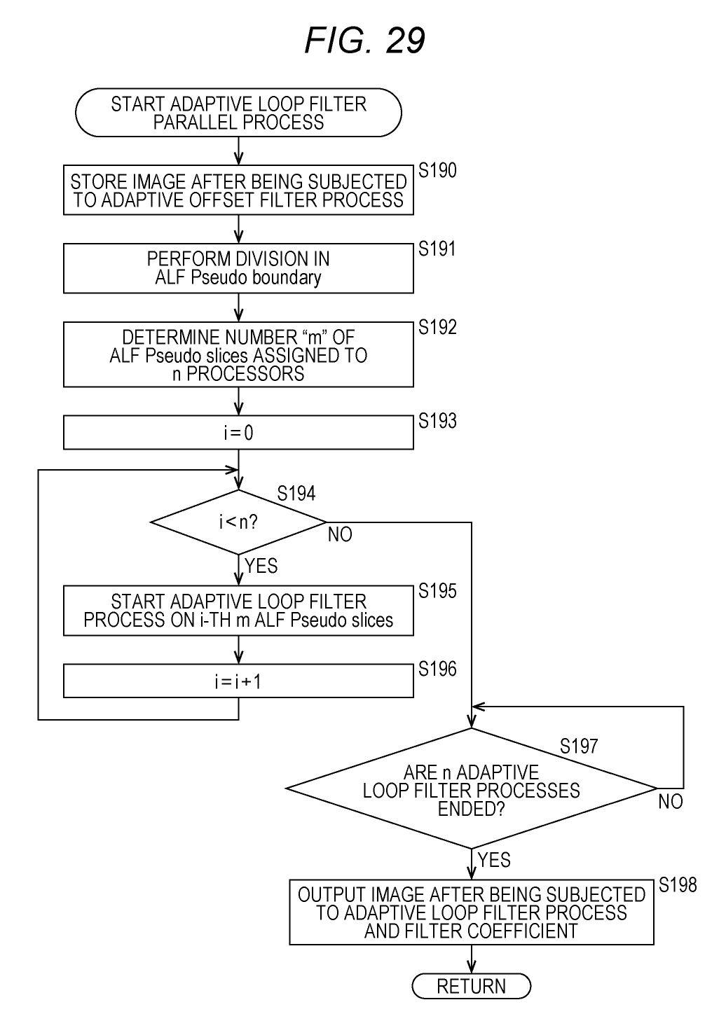

In step S48, the adaptive loop filter 43 performs an adaptive loop filter parallel process in which the adaptive loop filter process is performed in m parallel processing units ALF Pseudo Slice in parallel for each LCU on the image supplied from the adaptive offset filter 42. The details of the adaptive loop filter parallel process will be described below with reference to FIG. 29.

In step S49, the frame memory 44 accumulates the image supplied from the adaptive loop filter 43. The image is output as the reference image to the intra prediction unit 46 through the switch 45.

In step S50, the lossless encoding unit 36 performs the lossless encoding on the encoding information such as the intra prediction mode information or the inter prediction mode information, the motion vector, and information for specifying the reference image, the offset filter information, and the filter coefficient.

In step S51, the lossless encoding unit 36 performs the lossless encoding on the quantized coefficient supplied from the quantization unit 35. Then, the lossless encoding unit 36 generates the encoding data based on the lossless-encoded encoding information and the lossless-encoded coefficient through the process of step S50, and supplies the encoding data to the accumulation buffer 37.

In step S52, the accumulation buffer 37 temporarily accumulates the encoding data supplied from the lossless encoding unit 36.

In step S53, the rate control unit 49 controls a rate of the quantization operated by the quantization unit 35 based on the encoding data accumulated in the accumulation buffer 37 such that overflow or underfloor does not occur. In step S54, the accumulation buffer 37 transmits the encoding data which is stored therein.

Further, the description in step S33 has been made such that the intra prediction process and the motion prediction/compensation process are always performed to simplify the description. However, in practice, any one of the processes may be performed depending on the type of the picture.

FIG. 22 is a flowchart for describing the details of the inverse quantization parallel process of step S41 of FIG. 21.

In step S71 of FIG. 22, the inverse quantization unit 38 divides the quantized coefficient supplied from the quantization unit 35 into n (n is an integer of 2 or more) Recon Pseudo Slices. In step S72, the inverse quantization unit 38 sets a counter value i to 0.

In step S73, the inverse quantization unit 38 determines whether the counter value i is smaller than n. In a case where it is determined in step S73 that the counter value i is smaller than n, in step S74, an inverse quantization process is started on an i-th Recon Pseudo Slice among the divided Recon Pseudo Slices.

In step S75, the inverse quantization unit 38 increases the counter value i by 1. Then, the process returns to step S73, the processes of steps S73 to S75 are repeatedly performed until the counter value i becomes n or more (that is, until the inverse quantization process is started on all the divided Recon Pseudo Slices).

On the other hand, in a case where it is determined in step S73 that the counter value i is not smaller than n (that is, in a case where the inverse quantization process is started on all the divided Recon Pseudo Slices), the process proceeds to step S76. In step S76, the inverse quantization unit 38 determines whether all the n inverse quantization processes started in step S74 are ended, and in a case where it is determined that all the processes are not ended, the procedure waits for the end of all the processes.

In step S76, in a case where it is determined that all the n inverse quantization processes started in step S74 are ended, the inverse quantization unit 38 supplies the orthogonal transform coefficient obtained as the result of the inverse quantization process to the inverse orthogonal transform unit 39. Then, the process returns to step S41 of FIG. 21, and proceeds to step S42.

FIG. 23 is a flowchart for describing the details of the inverse orthogonal transform parallel process of step S42 of FIG. 21.

The processes of steps S91 to S96 of FIG. 23 are equal to the processes of steps S71 to S76 of FIG. 22 except that an inverse orthogonal transform process is performed instead of the inverse quantization process, and thus the description will not be repeated. Further, the residual information obtained as the result of the inverse orthogonal transform process is supplied to the addition unit 40.

FIG. 24 is a flowchart for describing the details of the inter prediction parallel process of step S43 of FIG. 21.

The processes of steps S111 to S116 of FIG. 24 are equal to the processes of steps S71 to S76 of FIG. 22 except that the compensation process of the optimal inter prediction mode which is performed in the Recon Pseudo Slice on the PU to which the selection of the predicted image generated in the optimal inter prediction mode is notified is performed instead of the inverse quantization process, and thus the description will not be repeated. Further, the predicted image obtained as the result of the compensation process is supplied to the addition unit 40.

FIG. 25 is a flowchart for describing the details of the addition parallel process of step S44 of FIG. 21.

The processes of steps S131 to S136 of FIG. 25 are equal to the processes of steps S71 to S76 of FIG. 22 except that the addition process of adding the predicted image of the PU in the Recon Pseudo Slice supplied from the motion prediction/compensation unit 47 and the residual information supplied from the inverse orthogonal transform unit 39 of the PU is performed instead of the inverse quantization process, and thus the description will not be repeated. Further, the decoded image obtained as the result of the addition process is supplied to the frame memory 44.

FIG. 26 is a flowchart for describing the details of the intra prediction process of step S45 of FIG. 21.

In step S140 of FIG. 26, the intra prediction unit 46 sets the counter value i to 0. In step S141, the intra prediction unit 46 determines whether the counter value i is smaller than the number of all the LCUs of the picture. In a case where it is determined in step S141 that the counter value i is smaller than the number of all the LCUs of the picture, the process proceeds to step S142.

In step S142, the intra prediction unit 46 sets a counter value j to 0. In step S143, the intra prediction unit 46 determines whether the counter value j is smaller than the number of all the PUs of in an i-th LCU. In a case where it is determined in step S143 that the optimal prediction mode of a j-th PU is the optimal intra prediction mode, in step S144, the intra prediction unit 46 determines whether the selection of the predicted image of the optimal intra prediction mode on the j-th PU of the i-th LCU in the picture is notified from the predicted image selection unit 48.

In a case where it is determined in step S144 that the selection of predicted image of the optimal intra prediction mode on the j-th PU is notified, the process proceeds to step S145. In step S145, the intra prediction unit 46 performs the intra prediction process of the optimal intra prediction mode on the j-th PU using the reference image supplied from the frame memory 44 through the switch 45. The intra prediction unit 46 supplies the predicted image of the j-th PU obtained as the result to the addition unit 40.

In step S146, the addition unit 40 adds the predicted image of the j-th PU supplied from the intra prediction unit 46 and the residual information supplied from the inverse orthogonal transform unit 39 of the PU, and supplies the decoded image in the PU obtained as the result of the addition to the frame memory 44.

In step S147, the frame memory 44 accumulates the decoded image in the PU supplied from the addition unit 40. The image is output as the reference image to the motion prediction/compensation unit 47 through the switch 45.

After the process of step S147, or in a case where it is determined in step S144 that the selection of the predicted image of the optimal intra prediction mode on the j-th PU is not notified, the intra prediction unit 46 increases the counter value j by 1 in the process in step S148. Then, the process returns to step S143, and the processes of steps S143 to S148 are performed until the counter value j is equal to or more than the number of all the PUs in the i-th LCU (that is, the processes of steps S144 to S148 are performed on all the PUs in the i-th LCU).

On the other hand, in a case where it is determined in step S143 that the counter value j is not smaller than the number of all the PUs in the i-th LCU (that is, in a case where the processes of steps S144 to S148 are performed on all the PUs in the i-th LCU), the process proceeds to step S149.

In step S149, the intra prediction unit 46 increases the counter value i by 1. Then, the process returns to step S141, and the processes of steps S143 to S148 are performed until the counter value i is equal to or more than the number of all the LCUs of the picture (that is, the processes of steps S142 to S149 are performed on all the LCUs of the picture).

In a case where it is determined in step S141 that the counter value i is smaller than the number of all the LCUs of the picture, the addition unit 40 supplies the decoded image of all the LCUs constituting the picture to the deblocking filter 41, and the process returns to step S45 of FIG. 21. Then, the process proceeds to step S46.

FIG. 27 is a flowchart for describing the details of the deblocking filter parallel process of step S46 of FIG. 21.

In step S150 of FIG. 27, the buffer 80 stores the decoded image supplied from the addition unit 40 of FIG. 1. In step S151, the division unit 81 divides the image of a picture unit stored in the buffer 80 into the units DBK Pseudo Slice in the De-blocking Pseudo boundary.

In step S152, the division unit 81 determines the number “m” of the units DBK Pseudo Slice which are assigned to the n processors 82-1 to 82-n. In step S153, the division unit 81 sets the counter value i to 0. In step S154, the division unit 81 determines whether the counter value i is smaller than n.

In a case where it is determined in step S154 that the counter value i is smaller than n, the division unit 81 supplies the i-th m units DBK Pseudo Slice to the processor 82-i. Then, in step S155, the processor 82-i starts the deblocking filter process on the i-th m units DBK Pseudo Slice. The units DBK Pseudo Slice after the deblocking filter process are supplied to the buffer 80 and stored therein.

In step S156, the division unit 81 increases the counter value i by 1, and the process returns to step S154. Then, the processes of steps S154 to S156 are repeatedly performed until the counter value i is equal to or more than n (that is, until the deblocking filter process is started in all the processors 82-1 to 82-n).

On the other hand, in a case where it is determined in step S154 that the counter value i is not smaller than n (that is, in a case where the deblocking filter process is started in the processors 82-1 to 82-n), the process proceeds to step S157. In step S157, the output unit 83 determines whether the n deblocking filter processes of the processors 82-1 to 82-n are ended.

In a case where it is determined in step S157 that the n deblocking filter processes of the processors 82-1 to 82-n are not ended, the output unit 83 waits for the end of the n deblocking filter processes.

In addition, in a case where it is determined in step S157 that the n deblocking filter processes are ended, in step S158, the output unit 83 outputs the image of a picture unit stored in the buffer 80 after being subjected to the deblocking filter process to the adaptive offset filter 42. Then, the process returns to step S46 of FIG. 21, and proceeds to step S47.

FIG. 28 is a flowchart for describing the details of the adaptive offset filter parallel process of step S47 of FIG. 21. Further, in FIG. 28, the description will be made of a case where the boundary of the parallel processing unit SAO Pseudo Slice is the LCU boundary 63 extending in the horizontal direction, but it is similarly applied to other cases where the boundary is not the LCU boundary 63.

In step S170 of FIG. 28, the buffer 110 stores the image which is supplied from the deblocking filter 41 of FIG. 1 and subjected to the deblocking filter process. In step S171, the division unit 111 divides the image of a picture unit stored in the buffer 110 into units SAO Pseudo Slice in the LCU boundary 63.

In step S172, the division unit 111 determines the number “m” of the units SAO Pseudo Slice which are assigned to the n processors 113-1 to 113-n. In step S173, the division unit 111 supplies the pixel values of the pixels in the uppermost row and the lowermost row of the units SAO Pseudo Slice after being subjected to the deblocking filter process to the buffer 112, and stores the pixel values therein.

In step S174, the division unit 111 sets the counter value i to 0. In step S175, the division unit 111 determines whether the counter value i is smaller than n.

In a case where it is determined in step S175 that the counter value i is smaller than n, the division unit 111 supplies the i-th m units SAO Pseudo Slice to the processor 113-i. Then, in step S176, the processor 113-i starts the adaptive offset filter process of each LCU on the i-th m units SAO Pseudo Slice. The unit SAO Pseudo Slice after being subjected to the adaptive offset filter process and the offset filter information of each LCU are supplied to the buffer 110, and stored therein.

In step S177, the division unit 111 increases the counter value i by 1, and the process returns to step S175. Then, the processes of steps S175 to S177 are repeatedly performed until the counter value i is equal to or more than n (that is, the adaptive offset filter process is started in all the processors 113-1 to 113-n).

On the other hand, in a case where it is determined in step S175 that the counter value i is not smaller than n (that is, in a case where the offset filter process is started in the processors 113-1 to 113-n), the process proceeds to step S178. In step S178, the output unit 114 determines whether the n adaptive offset filter processes by the processors 113-1 to 113-n are ended.

In a case where it is determined in step S178 that the n adaptive offset filter processes by the processors 113-1 to 113-n are not ended, the output unit 114 waits for the end of the n adaptive offset filter processes.

In addition, in a case where it is determined in step S178 that the n adaptive offset filter processes are ended, the process proceeds to step S179. In step S179, the output unit 114 outputs the image of a picture unit stored in the buffer 110 after being subjected to the adaptive offset filter process to the adaptive loop filter 43, and outputs the offset filter information of the corresponding LCU to the lossless encoding unit 36. Then, the process returns to step S47 of FIG. 21, and proceeds to step S48.

FIG. 29 is a flowchart for describing the details of the adaptive loop filter parallel process of step S48 of FIG. 21.

The processes of steps S190 to S198 of FIG. 29 are equal to the processes of steps S150 to S158 of FIG. 27 except that the boundary ALF Pseudo boundary is used instead of the boundary De-blocking Pseudo boundary, the unit ALF Pseudo Slice is used instead of the unit DBK Pseudo Slice, the adaptive loop filter process is used instead of the deblocking filter process, and the filter coefficient is output to the lossless encoding unit 36, and thus the description will not be repeated.

As described above, the encoding apparatus 11 can perform the deblocking filter process, an adaptive offset process, and the adaptive loop filter process in the predetermined processing unit in parallel on the decoded image. In addition, the encoding apparatus 11 can perform the inverse quantization, the inverse orthogonal transform, the addition process, and the compensation process in parallel in the Recon Pseudo Slice unit. Therefore, the decoding can be performed at a high speed at the time of encoding regardless of the setting of slices and tiles. As a result, the encoding can be performed at a high speed.

<Exemplary Configuration of First Embodiment of Decoding Apparatus>

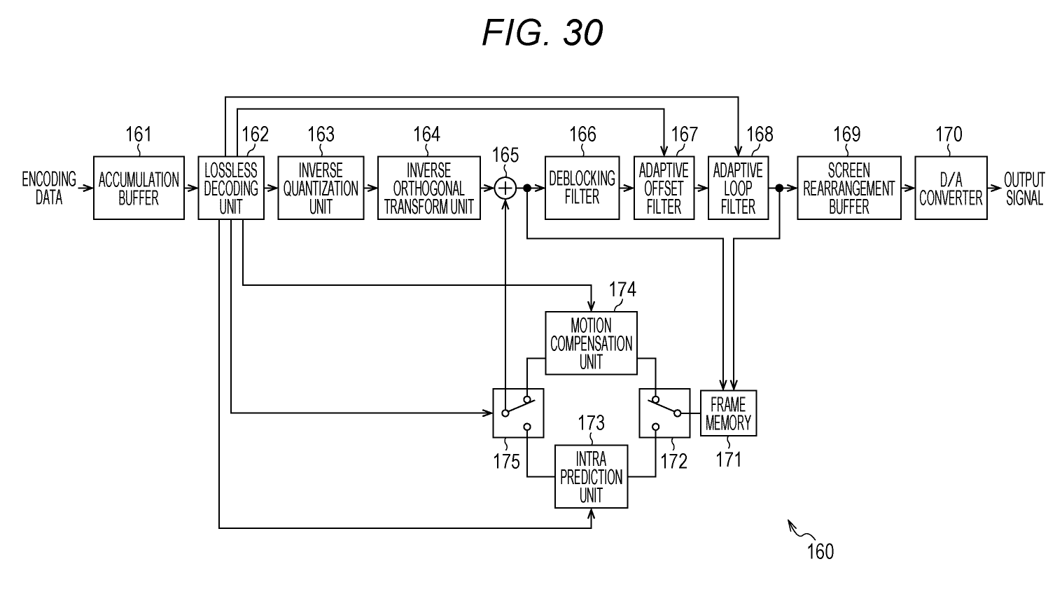

FIG. 30 is a block diagram illustrating an exemplary configuration of the first embodiment of a decoding apparatus as an image processing apparatus which decodes an encoding stream transmitted from the encoding apparatus 11 of FIG. 1 and to which the present technology is applied.

A decoding apparatus 160 of FIG. 30 includes an accumulation buffer 161, a lossless decoding unit 162, an inverse quantization unit 163, an inverse orthogonal transform unit 164, an addition unit 165, a deblocking filter 166, an adaptive offset filter 167, an adaptive loop filter 168, a screen rearrangement buffer 169, a D/A converter 170, a frame memory 171, a switch 172, an intra prediction unit 173, a motion compensation unit 174, and a switch 175.

The accumulation buffer 161 of the decoding apparatus 160 receives the encoding data transmitted from the encoding apparatus 11 of FIG. 1, and accumulates the encoding data therein. The accumulation buffer 161 supplies the accumulated encoding data to the lossless decoding unit 162.

The lossless decoding unit 162 acquires the quantized coefficient and the encoding information by performing the lossless decoding such as a variable length decoding and an arithmetic decoding on the encoding data from the accumulation buffer 161. The lossless decoding unit 162 supplies the quantized coefficient to the inverse quantization unit 163. In addition, the lossless decoding unit 162 supplies the intra prediction mode information and the like as the encoding information to the intra prediction unit 173, and supplies the motion vector, the inter prediction mode information, the information for specifying the reference image, and the like to the motion compensation unit 174.

Furthermore, the lossless decoding unit 162 supplies the intra prediction mode information or the inter prediction mode information as the encoding information to the switch 175. The lossless decoding unit 162 supplies the offset filter information as the encoding information to the adaptive offset filter 167, and supplies the filter coefficient to the adaptive loop filter 168.

The inverse quantization unit 163, the inverse orthogonal transform unit 164, the addition unit 165, the deblocking filter 166, the adaptive offset filter 167, the adaptive loop filter 168, the frame memory 171, the switch 172, the intra prediction unit 173, and the motion compensation unit 174 perform the same processes as those of the inverse quantization unit 38, the inverse orthogonal transform unit 39, the addition unit 40, the deblocking filter 41, the adaptive offset filter 42, the adaptive loop filter 43, the frame memory 44, the switch 45, the intra prediction unit 46, and the motion prediction/compensation unit 47 of FIG. 1, so that the image is decoded.

Specifically, the inverse quantization unit 163 performs the inverse quantization in the unit Recon Pseudo Slice in parallel on the quantized coefficient from the lossless decoding unit 162, and supplies the orthogonal transform coefficient obtained as the result to the inverse orthogonal transform unit 164.

The inverse orthogonal transform unit 164 performs the inverse orthogonal transform in the unit Recon Pseudo Slice in parallel on the orthogonal transform coefficient from the inverse quantization unit 163. The inverse orthogonal transform unit 164 supplies the residual information obtained as the result of the inverse orthogonal transform to the addition unit 165.

The addition unit 165 serves as the decoding unit, and locally performs the decoding by adding the residual information as the decoding target image supplied from the inverse orthogonal transform unit 164 and the predicted image supplied from the motion compensation unit 174 through the switch 175 in the unit Recon Pseudo Slice. Then, the addition unit 165 supplies the locally-decoded image to the frame memory 171.

In addition, the addition unit 165 locally performs the decoding by adding the predicted image of the PU supplied from the intra prediction unit 173 through the switch 175 and the residual information of the PU. Then, the addition unit 165 supplies the locally-decoded image to the frame memory 171. In addition, the addition unit 165 supplies the completely-decoded image of a picture unit to the deblocking filter 166.

The deblocking filter 166 performs the deblocking filter process in the m parallel processing units DBK Pseudo Slice in parallel on the image supplied from the addition unit 165, and supplies the image obtained as the result to the adaptive offset filter 167.

The adaptive offset filter 167 performs the adaptive offset filter process in the m parallel processing units SAO Pseudo Slice in parallel on the image of each LCU after being subjected to the deblocking filter process of the deblocking filter 166 based on the offset filter information of each LCU supplied from the lossless decoding unit 162. The adaptive offset filter 167 supplies the image after being subjected to the adaptive offset filter process to the adaptive loop filter 168.

The adaptive loop filter 168 performs the adaptive loop filter process in the m parallel processing units ALF Pseudo Slice in parallel on the image of each LCU supplied from the adaptive offset filter 167 using the filter coefficient of each LCU supplied from the lossless decoding unit 162. The adaptive loop filter 168 supplies the image obtained as the result to the frame memory 171 and the screen rearrangement buffer 169.

The screen rearrangement buffer 169 stores the image supplied from the adaptive loop filter 168 in a frame unit. The screen rearrangement buffer 169 rearranges the images of a frame unit stored in an encoding order to be arranged in the original display order, and supplies the images to the D/A converter 170.

The D/A converter 170 performs D/A conversion on the image of a frame unit supplied from the screen rearrangement buffer 169, and outputs the converted image as an output signal.

The frame memory 171 accumulates the image supplied from the adaptive loop filter 168 and the image supplied from the addition unit 165. The image which is accumulated in the frame memory 171 and supplied from the adaptive loop filter 168 is read as the reference image, and supplied to the motion compensation unit 174 through the switch 172. In addition, the image which is accumulated in the frame memory 171 and supplied from the addition unit 165 is read as the reference image, and supplied to the intra prediction unit 173 through the switch 172.

The intra prediction unit 173 performs the intra prediction process of the optimal intra prediction mode indicated by the intra prediction mode information supplied from the lossless decoding unit 162 in the PU using the reference image read from the frame memory 171 through the switch 172. The intra prediction unit 173 supplies the predicted image of the PU generated as the result to the switch 175.

The motion compensation unit 174 reads the reference image specified by the information for specifying the reference image supplied from the lossless decoding unit 162 in the unit Recon Pseudo Slice in parallel from the frame memory 171 through the switch 172. The motion compensation unit 174 performs a motion compensation process of the optimal inter prediction mode indicated by the inter prediction mode information supplied from the lossless decoding unit 162 in the unit Recon Pseudo Slice in parallel using the motion vector and the reference image supplied from the lossless decoding unit 162. The motion compensation unit 174 supplies the predicted image of a picture unit generated as the result to the switch 175.

In a case where the intra prediction mode information is supplied from the lossless decoding unit 162, the switch 175 supplies the predicted image of the PU supplied from the intra prediction unit 173 to the addition unit 165. On the other hand, in a case where the inter prediction mode information is supplied from the lossless decoding unit 162, the switch 175 supplies the predicted image of a picture unit supplied from the motion compensation unit 174 to the addition unit 165.

<Description of Process of Decoding Apparatus>

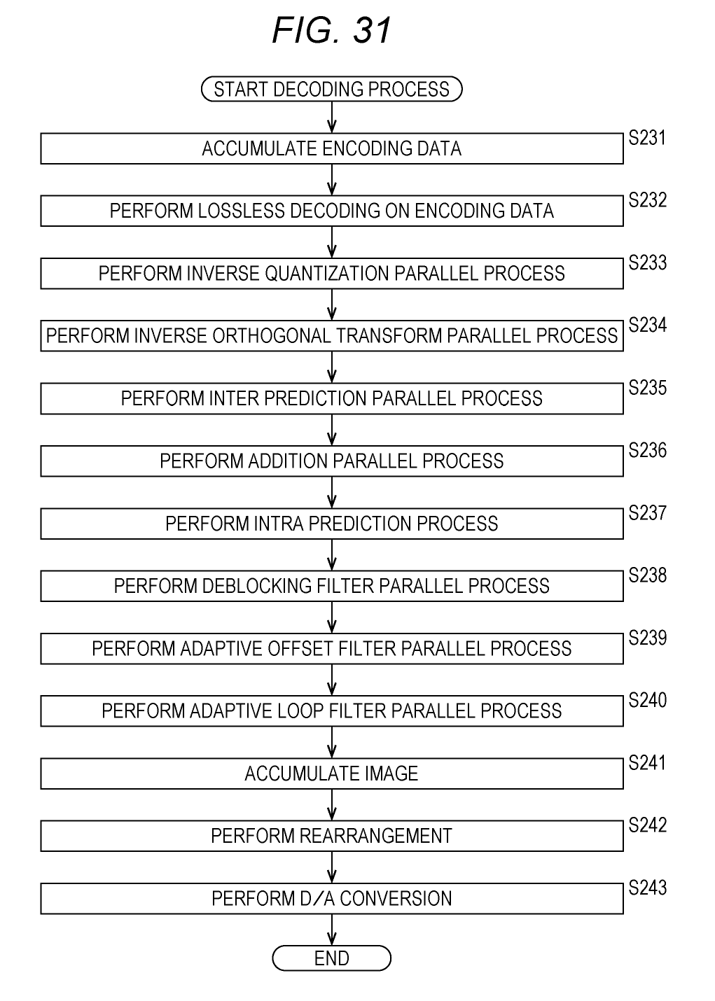

FIG. 31 is a flowchart for describing a decoding process of the decoding apparatus 160 of FIG. 30. The decoding process is performed in a frame unit.

In step S231 of FIG. 31, the accumulation buffer 161 of the decoding apparatus 160 receives the encoding data of a frame unit transmitted from the encoding apparatus 11 of FIG. 1 and accumulates the encoding data. The accumulation buffer 161 supplies the accumulated encoding data to the lossless decoding unit 162.

In step S232, the lossless decoding unit 162 performs the lossless decoding on the encoding data from the accumulation buffer 161, and acquires the quantized coefficient and the encoding information. The lossless decoding unit 162 supplies the quantized coefficient to the inverse quantization unit 163. In addition, the lossless decoding unit 162 supplies the intra prediction mode information and the like as the encoding information to the intra prediction unit 173, and supplies the motion vector, the inter prediction mode information, the information for specifying the reference image, and the like to the motion compensation unit 174.

Furthermore, the lossless decoding unit 162 supplies the intra prediction mode information or the inter prediction mode information as the encoding information to the switch 175. The lossless decoding unit 162 supplies the offset filter information as the encoding information to the adaptive offset filter 167, and supplies the filter coefficient to the adaptive loop filter 168.

In step S233, the inverse quantization unit 163 performs the same inverse quantization parallel process as the inverse quantization parallel process of FIG. 22 on the quantized coefficient from the lossless decoding unit 162. The orthogonal transform coefficient obtained as the result of the inverse quantization parallel process is supplied to the inverse orthogonal transform unit 164.

In step S234, the inverse orthogonal transform unit 164 performs the same inverse orthogonal transform parallel process as the inverse orthogonal transform parallel process of FIG. 23 on the orthogonal transform coefficient from the inverse quantization unit 163. The residual information obtained as the result of the inverse orthogonal transform parallel process is supplied to the addition unit 165.

In step S235, the motion compensation unit 174 performs the same inter prediction parallel process as the inter prediction parallel process of FIG. 24. Further, in the inter prediction parallel process, the compensation process of the optimal inter prediction mode is performed on the PU corresponding to the inter prediction mode information supplied from the lossless decoding unit 162 but not the PU to which the selection of the predicted image generated in the optimal inter prediction mode is notified.

In step S236, the addition unit 165 performs the same addition parallel process as the addition parallel process of FIG. 25 on the residual information supplied from the inverse orthogonal transform unit 164 and the predicted image supplied from the motion compensation unit 174 through the switch 175. The image obtained as the result of the addition parallel process is supplied to the frame memory 171.

In step S237, the intra prediction unit 173 performs the same intra prediction process as the intra prediction process of FIG. 26. Further, in the intra prediction process, the intra prediction process of the optimal intra prediction mode is performed on the PU corresponding to the intra prediction mode information supplied from the lossless decoding unit 162 but not the PU to which the selection of the predicted image generated in the optimal intra prediction mode is notified.

In step S238, the deblocking filter 166 performs the deblocking filter parallel process of FIG. 27 on the image supplied from the addition unit 165. The image of a picture unit obtained as the result of the deblocking filter parallel process is supplied to the adaptive offset filter 167.

In step S239, the adaptive offset filter 167 performs the same adaptive offset filter parallel process as the adaptive offset filter parallel process of FIG. 28 on the image supplied from the deblocking filter 166 based on the offset filter information of each LCU supplied from the lossless decoding unit 162. The image of a picture unit obtained as the result of the adaptive offset filter parallel process is supplied to the adaptive loop filter 168.

In step S240, the adaptive loop filter 168 performs the same adaptive loop filter parallel process as the adaptive loop filter parallel process of FIG. 29 on the image supplied from the adaptive offset filter 167 using the filter coefficient supplied from the lossless decoding unit 162. The image of a picture unit obtained as the result of the adaptive loop filter process is supplied to the frame memory 171 and the screen rearrangement buffer 169.

In step S241, the frame memory 171 accumulates the image supplied from the adaptive loop filter 168. The image which is accumulated in the frame memory 171 and supplied from the adaptive loop filter 168 is read as the reference image, and supplied to the motion compensation unit 174 through the switch 172. In addition, the image which is accumulated in the frame memory 171 and supplied from the addition unit 165 is read as the reference image, and supplied to the intra prediction unit 173 through the switch 172.

In step S242, the screen rearrangement buffer 169 stores the images supplied from the adaptive loop filter 168 in a frame unit, rearranges the images of a frame unit stored in the encoding order to be arranged in the original display order, and supplies the images to the D/A converter 170.

In step S243, the D/A converter 170 performs the D/A conversion on the image of a frame unit supplied from the screen rearrangement buffer 169, and outputs the converted image as the output signal. Then, the process is ended.

As described above, the decoding apparatus 160 can perform the deblocking filter process, the adaptive offset process, and the adaptive loop filter process in the predetermined processing unit in parallel on the decoded image. In addition, the decoding apparatus 160 can perform the inverse quantization, the inverse orthogonal transform, the addition process, and the compensation process in parallel in the unit Recon Pseudo Slice. Therefore, the decoding can be performed at a high speed regardless of the setting of slices and tiles.

### Second Embodiment

<Exemplary Configuration of Second Embodiment of Encoding Apparatus>

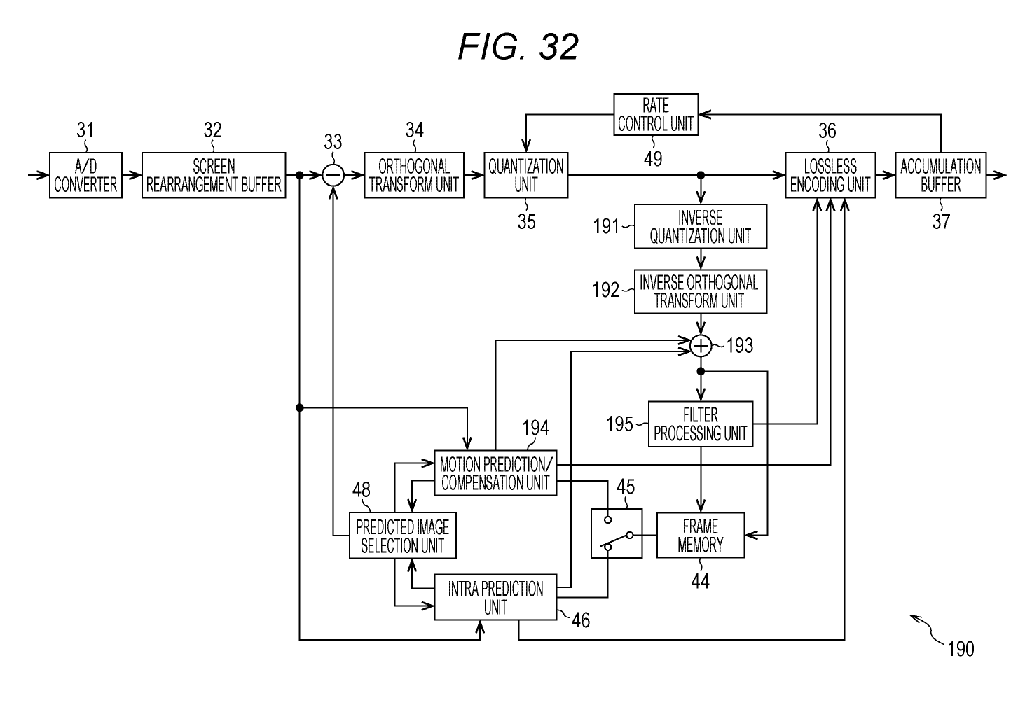

FIG. 32 is a block diagram illustrating an exemplary configuration of a second embodiment of an encoding apparatus as the image processing apparatus to which the present technology is applied.

Among the configurations illustrated in FIG. 32, the same configurations as the configurations of FIG. 1 will be denoted with the same symbols. The redundant descriptions will be appropriately omitted.

The configuration of an encoding apparatus 190 of FIG. 32 is different from the configuration of the encoding apparatus 11 of FIG. 1 in that an inverse quantization unit 191, an inverse orthogonal transform unit 192, an addition unit 193, and a motion prediction/compensation unit 194 are provided instead of the inverse quantization unit 38, the inverse orthogonal transform unit 39, the addition unit 40, and the motion prediction/compensation unit 47, and in that a filter processing unit 195 is provided instead of the deblocking filter 41, the adaptive offset filter 42, and the adaptive loop filter 43.

The encoding apparatus 190 collectively performs the inverse quantization, the inverse orthogonal transform, the addition process, and the compensation process in the unit Recon Pseudo Slice, and collectively performs the deblocking filter process, the adaptive offset filter process, and the adaptive loop filter process in the predetermined processing unit.

Specifically, the inverse quantization unit 191 of the encoding apparatus 190 performs the inverse quantization in the unit Recon Pseudo Slice in parallel on the coefficient quantized by the quantization unit 35, and supplies the orthogonal transform coefficient of the unit Recon Pseudo Slice obtained as the result to the inverse orthogonal transform unit 192.

The inverse orthogonal transform unit 192 performs the inverse orthogonal transform in parallel on the orthogonal transform coefficient of the unit Recon Pseudo Slice supplied from the inverse quantization unit 1, and supplies the residual information of the unit Recon Pseudo Slice obtained as the result to the addition unit 193.

The addition unit 193 serves as the decoding unit, and performs the addition process of adding the predicted image of the unit Recon Pseudo Slice supplied from the motion prediction/compensation unit 194 and the residual information of the unit Recon Pseudo Slice supplied from the inverse orthogonal transform unit 192 in parallel in the unit Recon Pseudo Slice. The addition unit 193 supplies the image of a picture unit obtained as the result of the addition process to the frame memory 44.

In addition, similarly to the addition unit 40 of FIG. 1, the addition unit 193 locally performs the decoding by performing the addition process of adding the predicted image of the PU supplied from the intra prediction unit 46 and the residual information in the PU. The addition unit 193 supplies the locally-decoded image of the PU obtained as the result to the frame memory 44. Furthermore, the addition unit 193 supplies the completely-decoded image of a picture unit to the filter processing unit 195.

The filter processing unit 195 performs the deblocking filter process, the adaptive offset filter process, and the adaptive loop filter process in m common processing units in parallel on the decoded image supplied from the addition unit 193. The common processing unit is a unit of an integer multiple of a minimum unit ALF Pseudo Slice Min when an integer multiple of the minimum unit DBK Pseudo Slice Min and the integer multiple of the minimum unit ALF Pseudo Slice Min are matched (for example, the minimum unit ALF Pseudo Slice Min).

The filter processing unit 195 supplies the image obtained as the result of the adaptive loop filter process to the frame memory 44. In addition, the filter processing unit 195 supplies the offset filter information and the filter coefficient of each LCU to the lossless encoding unit 36.

Similarly to the motion prediction/compensation unit 47 of FIG. 1, the motion prediction/compensation unit 194 performs the motion prediction/compensation process of all the inter prediction modes as the candidates, and generates the predicted image and determines the optimal inter prediction mode. Then, similarly to the motion prediction/compensation unit 47, the motion prediction/compensation unit 194 supplies the cost function value of the optimal inter prediction mode and the corresponding predicted image to the predicted image selection unit 48.

Similarly to the motion prediction/compensation unit 47, in a case where the selection of the predicted image generated in the optimal inter prediction mode is notified from the predicted image selection unit 48, the motion prediction/compensation unit 194 outputs the inter prediction mode information, the corresponding motion vector, the information for specifying the reference image, and the like to the lossless encoding unit 36. In addition, based on the corresponding motion vector, the motion prediction/compensation unit 194 performs the compensation process of the optimal inter prediction mode on the reference image specified by the information for specifying the reference image in the unit Recon Pseudo Slice in parallel on the PU to which the selection of the predicted image generated in the optimal inter prediction mode is notified from the predicted image selection unit 48. The motion prediction/compensation unit 194 supplies the predicted image of the unit Recon Pseudo Slice obtained as the result to the addition unit 193.

<Exemplary Configuration of Filter Processing Unit>

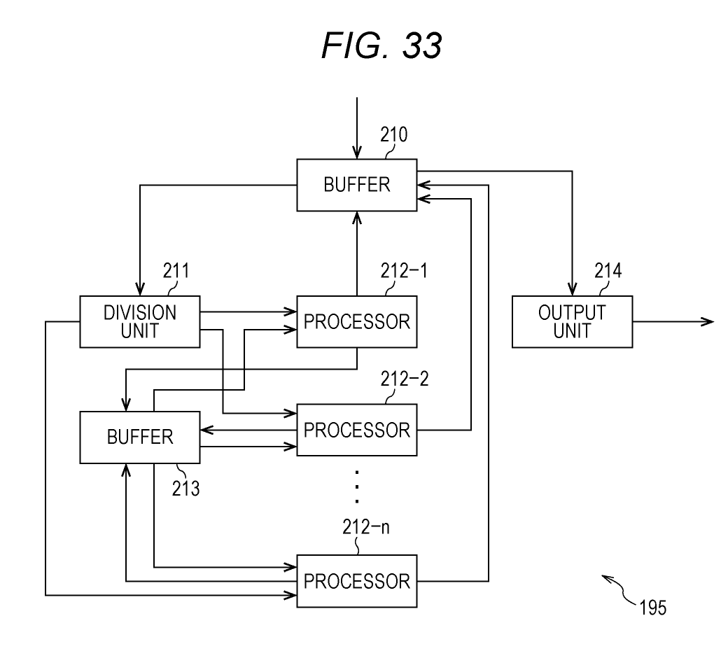

FIG. 33 is a block diagram illustrating an exemplary configuration of the filter processing unit 195 of FIG. 32.

The filter processing unit 195 of FIG. 33 includes a buffer 210, a division unit 211, processors 212-1 to 212-n, a buffer 213, and an output unit 214.

The buffer 210 of the filter processing unit 195 stores the completely-decoded image supplied from the addition unit 193 of FIG. 32 in a picture unit. In addition, the buffer 210 updates the decoded image with the images supplied from the processors 212-1 to 212-n after being subjected to the adaptive loop filter process. In addition, the buffer 210 stores the offset filter information and the filter coefficient of each LCU supplied from the processors 212-1 to 212-n in association with the image after being subjected to the adaptive loop filter process.

The division unit 211 divides the image stored in the buffer 210 into the n×m common processing units. The division unit 211 supplies the images of the n×m divided common processing units to the processors 212-1 to 212-n by m pieces.

The processors 212-1 to 212-n each perform the deblocking filter process on the images of the common processing unit supplied from the division unit 211. The processors 212-1 to 212-n each supply the pixel values of the pixels in the boundary of the common processing unit among the image of the common processing unit after being subjected to the deblocking filter process to the buffer 213, and store the pixel values therein.

Then, the processors 212-1 to 212-n each perform the adaptive offset filter process on the images of the common processing unit after being subjected to the deblocking filter process using the pixel values stored in the buffer 213.

Thereafter, the processors 212-1 to 212-n each perform the adaptive loop filter process on the images the common processing unit after being subjected to the adaptive offset filter process. The processors 212-1 to 212-n each supply the images of each LCU after being subjected to the adaptive loop filter process, the offset filter information, and the filter coefficient to the buffer 210.

The buffer 213 stores the pixel values supplied from the processors 212-1 to 212-n. The output unit 214 supplies the image of a picture unit stored in the buffer 210 to the frame memory 44 of FIG. 32, and supplies the offset filter information and the filter coefficient of each LCU to the lossless encoding unit 36.

<Description of Process of Encoding Apparatus>

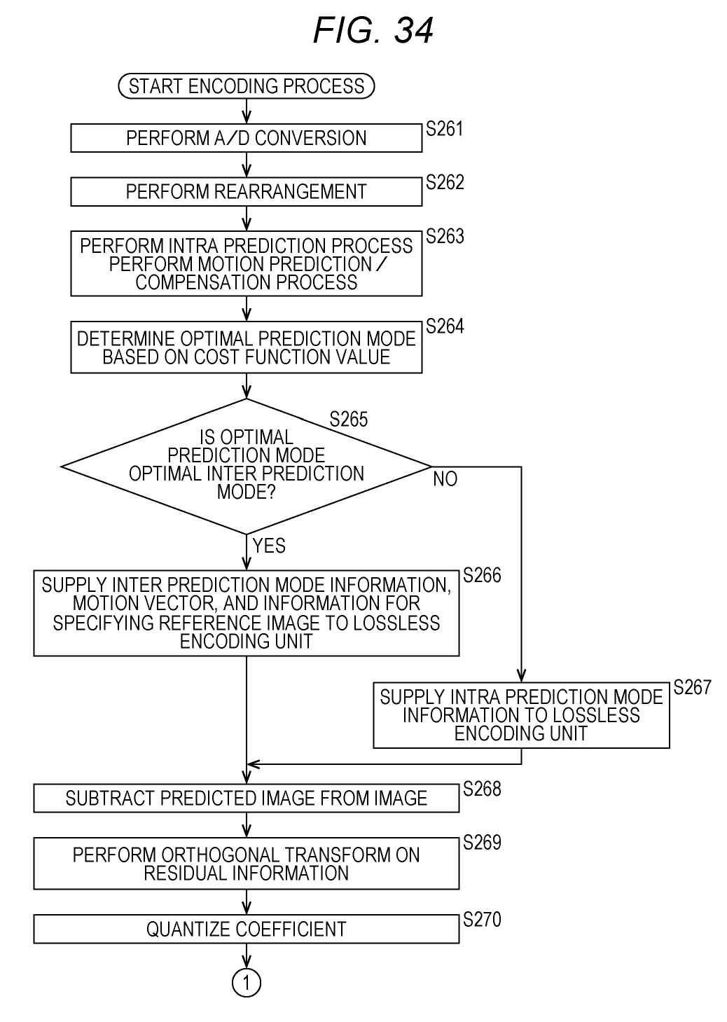

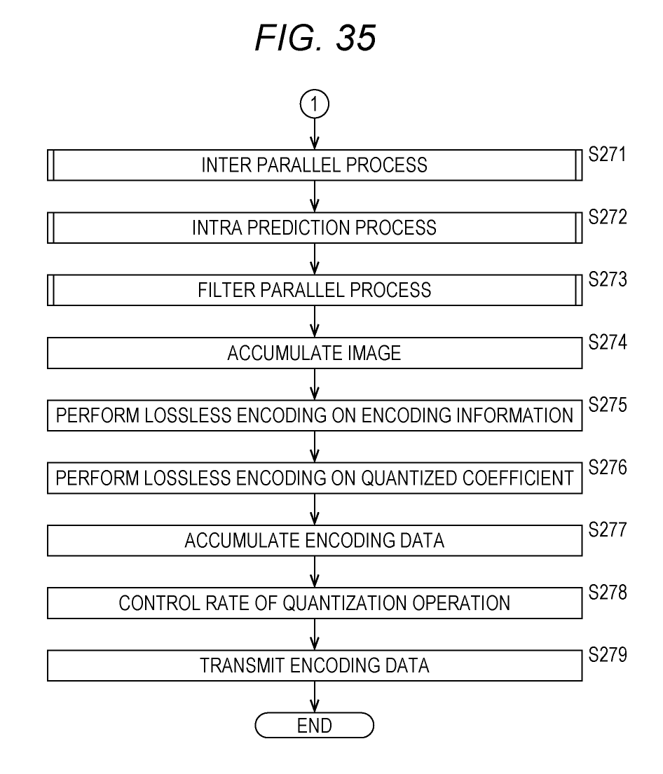

FIGS. 34 and 35 are flowcharts for describing the encoding process of the encoding apparatus 190 of FIG. 32.

The processes of steps S261 to S270 of FIG. 34 are the same as the processes of steps S31 to S40 of FIG. 20, and thus the descriptions thereof will not be repeated. The encoding process, for example, is performed in a frame unit.

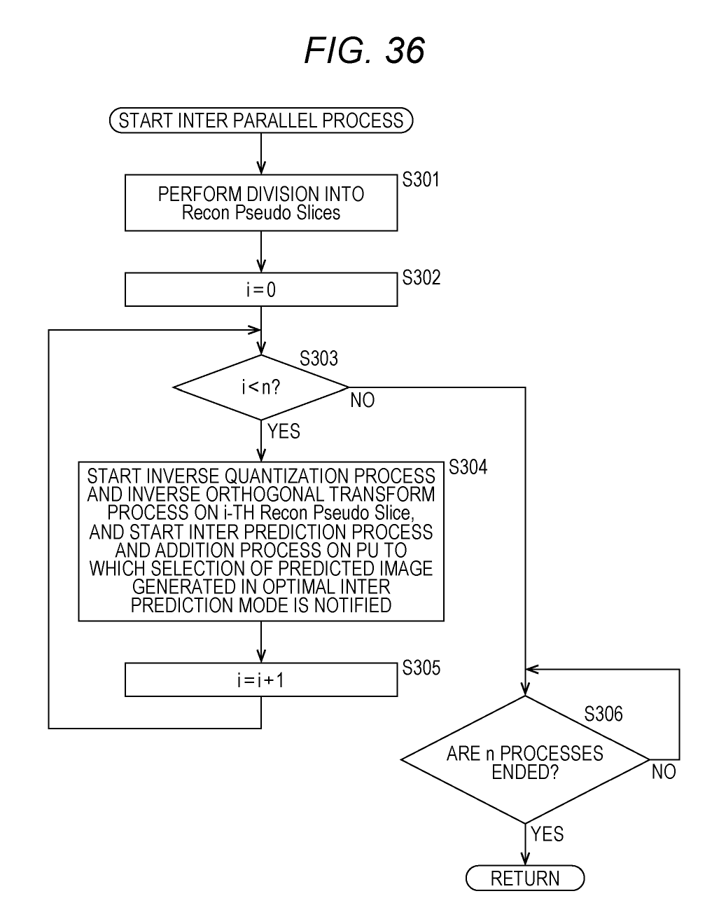

In step S271 of FIG. 35, the encoding apparatus 190 performs an inter parallel process of collectively performing the inverse quantization, the inverse orthogonal transform, the addition process, and the compensation process in parallel in the unit Recon Pseudo Slice. The details of the inter parallel process will be described below with reference to FIG. 36.

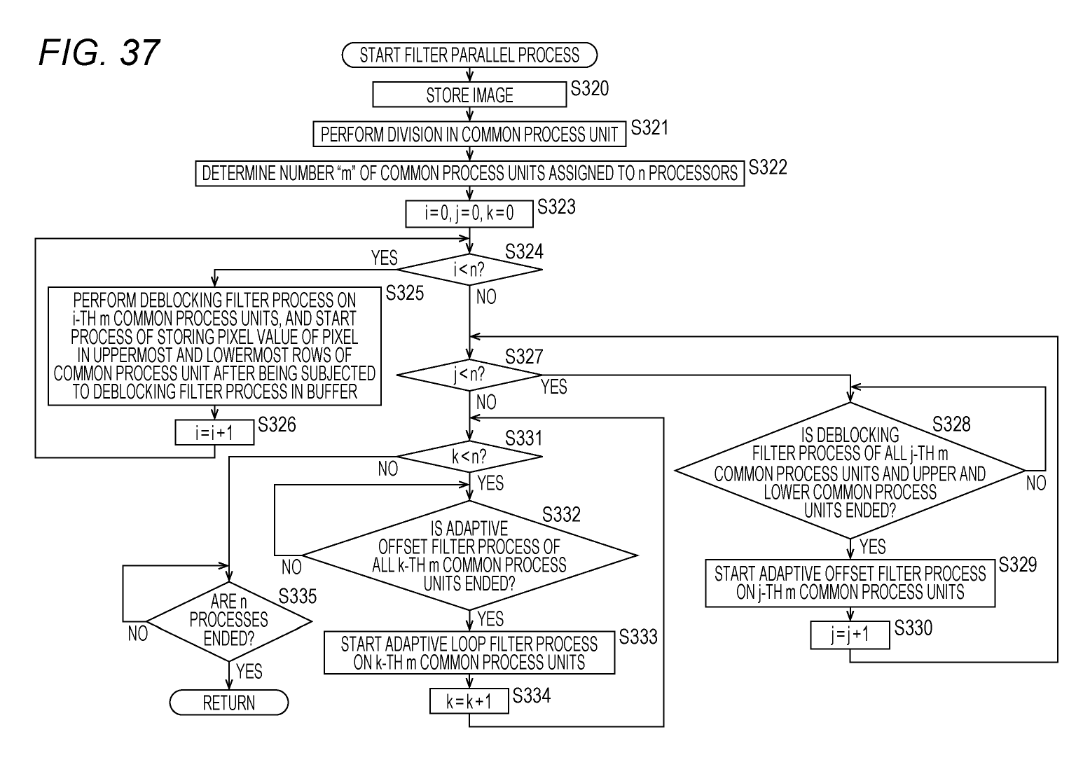

In step S272, the intra prediction unit 46 performs the intra prediction process of FIG. 26. In step S273, the encoding apparatus 190 performs a filter parallel process of collectively performing the deblocking filter process, the adaptive offset filter process, and the adaptive loop filter process in parallel in the m common parallel processing units. The details of the filter parallel process will be described below with reference to FIG. 37.

The processes of steps S274 to S279 are equal to the processes of steps S49 to S54 of FIG. 21, and thus the descriptions thereof will not be repeated.

FIG. 36 is a flowchart for describing the details of the inter parallel process of step S271 of FIG. 35.

In step S301 of FIG. 36, the inverse quantization unit 191 divides the coefficient supplied from the quantization unit 35 in the unit Recon Pseudo Slice. In step S302, the inverse quantization unit 191 sets the counter value i to 0. In step S303, it is determined whether the counter value i is smaller than the number of pieces n.

In a case where it is determined in step S303 that the counter value i is smaller than the number of pieces n, in step S304, the inverse quantization unit 191 starts the inverse quantization process on the i-th unit Recon Pseudo Slice. Then, after the inverse quantization process is ended, the inverse orthogonal transform unit 192 starts the inverse orthogonal transform process on the i-th unit Recon Pseudo Slice. Then, after the inverse orthogonal transform process is ended, the motion prediction/compensation unit 194 starts an inter prediction process on the PU to which the selection of the predicted image generated in the optimal inter prediction mode is notified from the predicted image selection unit 48 in the i-th unit Recon Pseudo Slice. After the inter prediction process is ended, the addition unit 193 starts the addition process on the i-th unit Recon Pseudo Slice.

In step S305, the inverse quantization unit 191 increases the counter value i by 1, and the process returns to step S303. Then, until the counter value i is n or more, the processes of steps S303 to S305 are repeatedly performed.

In a case where it is determined in step S303 that the counter value i is not smaller than n (that is, in a case where the process of step S304 is started on all the n units Recon Pseudo Slice), the process proceeds to step S306.

In step S306, the encoding apparatus 190 determines whether the process of step S304 of all the n units Recon Pseudo Slice is ended, and in a case where it is determined that the process is not ended, the procedure waits for the end of the process.

In a case where it is determined in step S306 that the process of step S304 of all the n units Recon Pseudo Slice is ended, the addition unit 193 supplies the locally-decoded image of a picture unit obtained as the result of the addition process to the frame memory 44. Then, the process returns to step S271 of FIG. 35, and proceeds to step S272.

FIG. 37 is a flowchart for describing the details of the filter parallel process of step S273 of FIG. 35.

In step S320 of FIG. 37, the buffer 210 of the filter processing unit 195 stores the decoded image of a picture unit supplied from the addition unit 193 of FIG. 32. In step S321, the division unit 211 divides the image of a picture unit stored in the buffer 210 in the common processing unit. For example, in a case where the common processing unit is the minimum unit ALF Pseudo Slice, the filter processing unit 195 divides the image of a picture unit in the boundary ALF Pseudo boundary.

In step S322, the division unit 211 determines the number “m” of common processing units which are assigned to the n processors 212-1 to 212-n. In step S323, the division unit 211 sets the counter values i, j, and k to 0.

In step S324, the division unit 211 determines whether the counter value i is smaller than n. In a case where it is determined in step S324 that the counter value i is smaller than n, the division unit 211 supplies the image of the i-th m common processing units to the processor 212-i, and the process proceeds to step S325.

In step S325, the processor 212-i performs the deblocking filter process on the i-th m common processing units, and starts a process of storing the pixel values of the pixels in the uppermost row and the lowermost row of the common processing unit in the buffer 213.

In step S326, the division unit 211 increases the counter value i by 1, and the process returns to step S324. Then, the processes of steps S324 to S326 are repeatedly performed until the counter value i is n or more.

On the other hand, in a case where it is determined in step S324 that the counter value i is not smaller than n (that is, in a case where the process of step S325 is started on all the common processing units in the picture), the process proceeds to step S327.

In step S327, the division unit 211 determines whether the counter value j is smaller than n. In a case where it is determined in step S327 that the counter value j is smaller than n, the process proceeds to step S328.

In step S328, the processor 212-j determines whether the deblocking filter process on all the j-th m common processing units and the common processing units above and below the m common processing units is ended.

In a case where it is determined in step S328 that the deblocking filter process on all the j-th m common processing units and the common processing units above and below the m common processing units is not ended, the procedure waits for the end of the process.

In a case where it is determined in step S328 that the deblocking filter process on all the j-th m common processing units and the common processing units above and below the m common processing units is ended, the process proceeds to step S329.

In step S329, the processor 212-j starts the adaptive offset filter process on the j-th m common processing units using the pixel value stored in the buffer 213. In step S330, the processor 212-j increases the counter value j by 1, and the process returns to step S327. Then, the processes of steps S327 to S330 are repeatedly performed until the counter value j is n or more.

In a case where it is determined in step S327 that the counter value j is not smaller than n (that is, in a case where the process of step S329 is started on all the common processing units in the picture, the process proceeds to step S331.

In step S331, it is determined whether the counter value k is smaller than n. In a case where it is determined in step S331 that the counter value k is smaller than n, the process proceeds to step S332.

In step S332, the processor 212-k determines whether the adaptive offset filter process on all the k-th m common processing units is ended, and in a case where it is determined that the process is not ended, the procedure waits for the end of the process.

In a case where it is determined in step S332 that the adaptive offset filter process on all the k-th m common processing units is ended, the process proceeds to step S333. In step S333, the processor 212-k starts the adaptive loop filter process on the k-th m common processing units.

In step S334, the processor 212-k increases the counter value k by 1, and the process proceeds to step S331. Then, the processes of steps S331 to S334 are repeatedly performed until the counter value k is n or more.

In a case where it is determined in step S331 that the counter value k is not smaller than n (that is, in a case where the process of step S333 on all the common processing units in the picture is started), the process proceeds to step S335. In step S335, the output unit 214 determines whether the adaptive loop filter process by the n processors 212-1 to 212-n is ended, and in a case where it is determined that the process is not ended, the procedure waits for the end of the process.

In a case where it is determined in step S331 that the adaptive loop filter process by the n processors 212-1 to 212-n is ended, the output unit 214 supplies the image of a picture unit after being subjected to the adaptive loop filter process stored in the buffer 210 to the frame memory 44. Then, the process returns to step S273 of FIG. 35, and proceeds to step S274.

As described above, the encoding apparatus 190 can collectively perform the deblocking filter process, the adaptive offset process, and the adaptive loop filter process in the m common parallel processing units in parallel on the decoded image. In addition, the encoding apparatus 190 can collectively perform the inverse quantization, the inverse orthogonal transform, the addition process, and the compensation process in parallel in the unit Recon Pseudo Slice.

Therefore, the process of the division in the parallel processing unit can be eliminated compared to the encoding apparatus 11. In addition, the next process can be performed without waiting for the end of each process on the entire picture. Accordingly, the encoding can be performed at a higher speed.

<Exemplary Configuration of Second Embodiment of Decoding Apparatus>

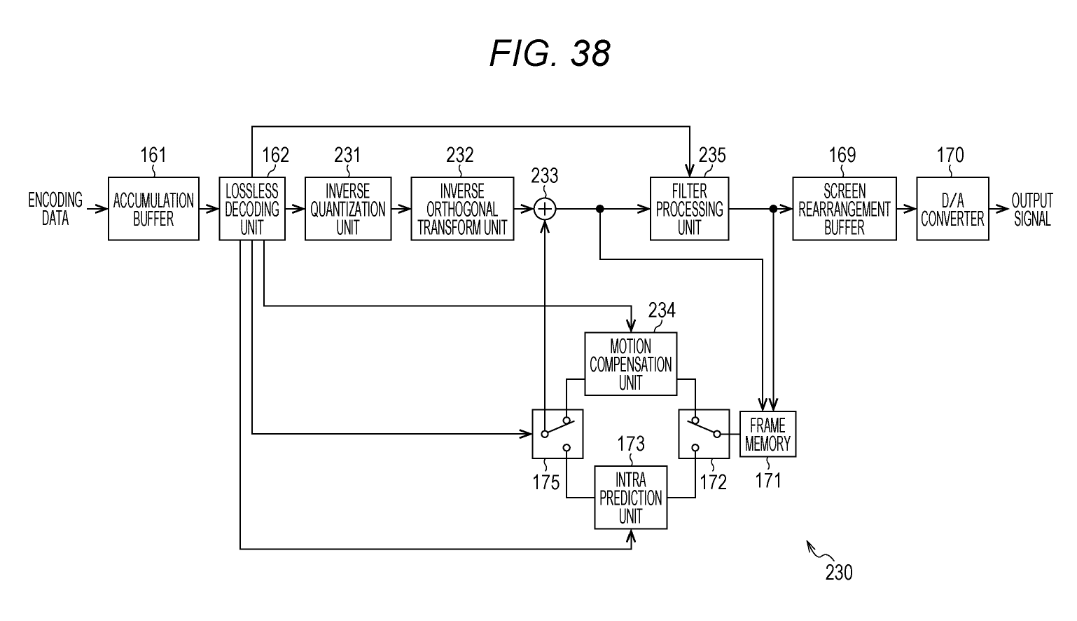

FIG. 38 is a block diagram illustrating an exemplary configuration of the second embodiment of a decoding apparatus as an image processing apparatus which decodes an encoding stream transmitted from the encoding apparatus 190 of FIG. 32 and to which the present technology is applied.

Among the configurations illustrated in FIG. 38, the same configurations as the configurations of FIG. 30 will be denoted with the same symbols. The redundant descriptions will be appropriately omitted.

The configuration of a decoding apparatus 230 of FIG. 38 is different from the configuration of the decoding apparatus 160 of FIG. 30 in that an inverse quantization unit 231, an inverse orthogonal transform unit 232, an addition unit 233, a motion prediction/compensation unit 234 are provided instead of the inverse quantization unit 163, the inverse orthogonal transform unit 164, the addition unit 165, the motion prediction/compensation unit 174, and in that a filter processing unit 235 is provided instead of the deblocking filter 166, the adaptive offset filter 167, and the adaptive loop filter 168.

The decoding apparatus 230 collectively performs the inverse quantization, the inverse orthogonal transform, the addition process, and the compensation process in the unit Recon Pseudo Slice, and collectively performs the deblocking filter process, the adaptive offset filter process, and the adaptive loop filter process in the m common process units.

Specifically, the inverse quantization unit 231 of the decoding apparatus 230 performs the inverse quantization in the unit Recon Pseudo Slice in parallel on the quantized coefficient supplied from the lossless decoding unit 162, and supplies the orthogonal transform coefficient of the unit Recon Pseudo Slice obtained as the result to the inverse orthogonal transform unit 232.

The inverse orthogonal transform unit 232 performs the inverse orthogonal transform in the unit Recon Pseudo Slice in parallel on the orthogonal transform coefficient of the unit Recon Pseudo Slice supplied from the inverse quantization unit 231. The inverse orthogonal transform unit 232 supplies the residual information of the unit Recon Pseudo Slice obtained as the result of the inverse orthogonal transform to the addition unit 233.

The addition unit 233 serves as the decoding unit, and locally performs the decoding by adding the residual information of the unit Recon Pseudo Slice as the decoding target image supplied from the inverse orthogonal transform unit 232 and the predicted image of the unit Recon Pseudo Slice supplied from a motion compensation unit 234 through the switch 175 in the unit Recon Pseudo Slice. Then, the addition unit 233 supplies the locally-decoded image of a picture unit to the frame memory 171.

In addition, similarly to the addition unit 165 of FIG. 30, the addition unit 233 locally performs the decoding by adding the predicted image of the PU supplied from the intra prediction unit 173 through the switch 175 and the residual information of the PU. Then, similarly to the addition unit 165, the addition unit 233 supplies the locally-decoded image of a picture unit to the frame memory 171. In addition, the addition unit 233 supplies the completely-decoded image of a picture unit to the filter processing unit 235.

The motion compensation unit 234 reads the reference image, in the unit Recon Pseudo Slice in parallel, specified by the information for specifying the reference image supplied from the lossless decoding unit 162 from the frame memory 171 through the switch 172. The motion compensation unit 234 performs the motion compensation process of the optimal inter prediction mode indicated by the inter prediction mode information supplied from the lossless decoding unit 162 in the unit Recon Pseudo Slice using the motion vector and the reference image supplied from the lossless decoding unit 162. The motion compensation unit 234 supplies the predicted image of the unit Recon Pseudo Slice generated as the result to the switch 175.

The filter processing unit 235 is configured similarly to the filter processing unit 195 of FIG. 32. The filter processing unit 235 performs the deblocking filter process, the adaptive offset filter process using the offset filter information supplied from the lossless decoding unit 162, and the adaptive loop filter process using the filter coefficient in the m common processing units in parallel on the image supplied from the addition unit 233. The filter processing unit 235 supplies the image of a picture unit obtained as the result to the frame memory 171 and the screen rearrangement buffer 169.

<Description of Process of Decoding Apparatus>

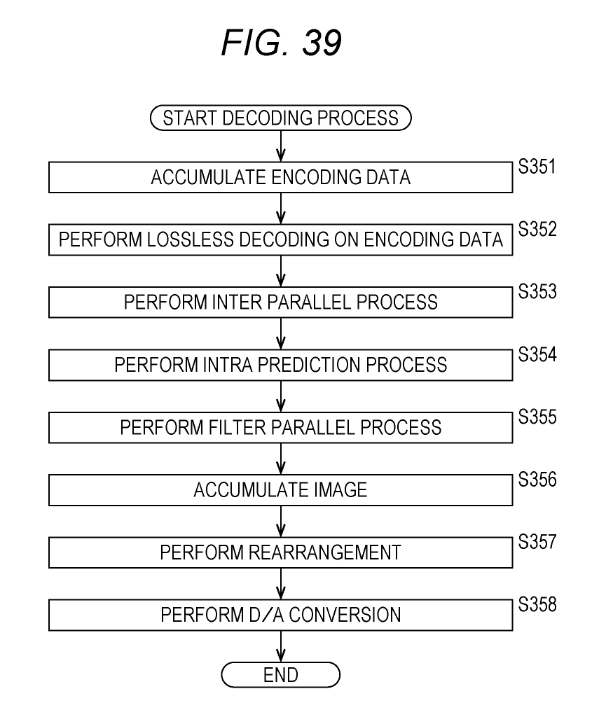

FIG. 39 is a flowchart for describing the decoding process of the decoding apparatus 230 of FIG. 38.

The processes of steps S351 and S352 of FIG. 39 are equal to the processes of steps S231 and S232 of FIG. 31, and thus the description will not be repeated.

In step S353, the decoding apparatus 230 performs the same inter parallel process as the inter parallel process of FIG. 36. In step S354, the intra prediction unit 173 performs the intra prediction process similarly to the process of step S237 of FIG. 31. In step S355, the filter processing unit 235 performs the same filter parallel process as the filter parallel process of FIG. 37.

The processes of steps S356 to S358 are equal to the processes of steps S241 to S243 of FIG. 31, and thus the description will not be repeated.

As described above, the decoding apparatus 230 can collectively perform the deblocking filter process, the adaptive offset process, and the adaptive loop filter process in the predetermined processing unit in parallel on the decoded image. In addition, the decoding apparatus 230 can collectively perform the inverse quantization, the inverse orthogonal transform, the addition process, and the compensation process in parallel in the unit Recon Pseudo Slice. Therefore, the process of the division in the parallel processing unit can be eliminated compared to the decoding apparatus 160. In addition, the next process can be performed without waiting for the end of each process on the entire picture. Accordingly, the decoding can be performed at a higher speed.

### Third Embodiment

<Description of Computer to which Present Technology is Applied>

A series of processes described above may be performed by hardware, or may be performed by software. In a case where a series of processes is performed by software, programs constituting the software are installed in the computer. Herein, the computer includes a computer which is assembled in a dedicated hardware and a computer (for example, a general-purpose personal computer) which can perform various types of functions by installing various types of programs.

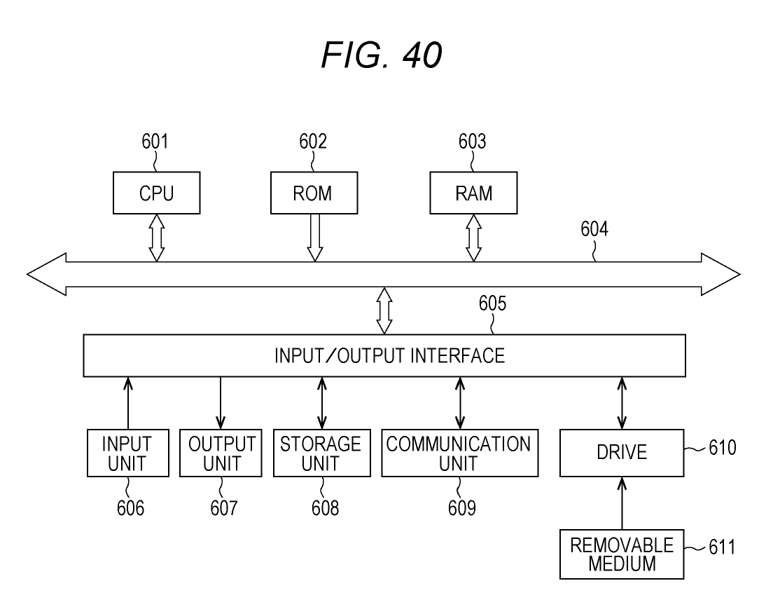

FIG. 40 is a block diagram illustrating an exemplary hardware configuration of a computer which performs a series of processes described above using programs.

In the computer, a CPU (Central Processing Unit) 601, a ROM (Read Only Memory) 602, and a RAM (Random Access Memory) 603 are connected to each other through a bus 604.

An input/output interface 605 is further connected to the bus 604. An input unit 606, an output unit 607, a storage unit 608, a communication unit 609, and a drive 610 are connected to the input/output interface 605.

The input unit 606 includes a keyboard, a mouse, a microphone, and the like. The output unit 607 includes a display, a speaker, and the like. The storage unit 608 includes a hard disk, a nonvolatile memory, and the like. The communication unit 609 includes a network interface and the like. The drive 610 drives a removable medium 611 such as a magnetic disk, an optical disk, a magneto-optical disk, or a semiconductor memory.

In the computer having the configuration as described above, the CPU 601, for example, performs a series of processes described above by loading the program stored in the storage unit 608 into the RAM 603 through the input/output interface 605 and the bus 604 and executing the program.

The program executed by the computer (the CPU 601), for example, may be provided by the removable medium 611 such as a package medium recorded therein. In addition, the program may be provided through a wired or wireless transmission medium such as a local area network, the Internet, or a digital satellite broadcasting.

In the computer, the program may be installed in the storage unit 608 through the input/output interface 605 by mounting the removable medium 611 in the drive 610. In addition, the program may be received by the communication unit 609 through the wired or wireless transmission medium, and installed in the storage unit 608. Besides, the program may be installed in the ROM 602 or the storage unit 608 in advance.

Further, the program executed by the computer may be a program which causes the processes to be performed in time series along the order described in the present specification, or may be a program which causes the processes to be performed in parallel or at necessary timing (for example, at the time of calling).

Further, in a case where a series of processes described above is performed by software, the parallel process is performed using threads.

In addition, embodiments of the present technology are not limited to the above-mentioned embodiments, and various changes can be made in a scope not departing from the spirit of the present technology.

For example, the present technology may be configured by a cloud computing system in which one function is distributed in a plurality of apparatuses through the network and the process is shared.

In addition, the respective steps described in the above-mentioned flowcharts may be performed by one apparatus, or may be performed in the plurality of distributed apparatuses.

Furthermore, in a case where a plurality of processes is included in one step, the plurality of processes included in one step may be performed by one apparatus, or may be performed by the plurality of distributed apparatuses.

In addition, the inverse quantization unit 38, the inverse orthogonal transform unit 39, the addition unit 40, the motion prediction/compensation unit 47, the inverse quantization unit 163, the inverse orthogonal transform unit 164, the addition unit 165, and the motion compensation unit 174 in the first embodiment may be provided instead of the inverse quantization unit 191, the inverse orthogonal transform unit 192, the addition unit 193, the motion prediction/compensation unit 194, the inverse quantization unit 231, the inverse orthogonal transform unit 232, the addition unit 233, and the motion compensation unit 234 of the second embodiment. In addition, instead of the deblocking filter 41, the adaptive offset filter 42, and the adaptive loop filter 43, and the deblocking filter 166, the adaptive offset filter 167, and the adaptive loop filter 168 of the first embodiment, the filter processing unit 195 and the filter processing unit 235 in the second embodiment may be provided.

Further, the present technology may be configured as follows.

(1)

An image processing apparatus including:

a decoding unit configured to decode encoding data and generate an image; and

a filter processing unit configured to perform a filter process in a processing unit regardless of a slice in parallel on the image generated by the decoding unit.

(2)

The image processing apparatus according to (1), wherein

the filter process is a deblocking filter process, and

the number of pixels in a horizontal or vertical direction of the processing unit is a multiple of 8.

(3)

The image processing apparatus according to (2), wherein

the pixels in the horizontal or vertical direction of the processing unit include four pixels with a boundary of an LCU (Largest Coding Unit) as the center.

(4)

The image processing apparatus according to (2) or (3), wherein

in a case where the image is a luminance image of YUV420, the number of pixels in the horizontal or vertical direction of the processing unit is a multiple of 8, and

in a case where the image is a color image of YUV420, the number of pixels in the horizontal or vertical direction of the processing unit is a multiple of 4.

(5)

The image processing apparatus according to (2) or (3), wherein

in a case where the image is a color image of YUV422, the number of pixels in the horizontal direction of the processing unit is a multiple of 4, and the number of pixels in the vertical direction is a multiple of 8.

(6)

The image processing apparatus according to (2) or (3), wherein

in a case where the image is a color image of YUV444, the number of pixels in the horizontal or vertical direction of the processing unit is a multiple of 8.

(7)

The image processing apparatus according to (1), wherein

the filter processing unit includes

a storage unit configured to store a pixel value of a pixel in a boundary of the processing unit of the image, and

a processor configured to perform an adaptive offset filter process in the processing unit in parallel on the image using the pixel value stored by the storage unit.

(8)

The image processing apparatus according to (7), wherein

the processing unit is a largest coding unit (LCU).

(9)

The image processing apparatus according to (1), wherein

the filter process includes a deblocking filter process and an adaptive offset filter process, and

the number of pixels in a horizontal or vertical direction of the processing unit is a multiple of 8.

(10)

The image processing apparatus according to (9), wherein

in a case where the image is a luminance image of YUV420, the number of pixels in the horizontal or vertical direction of the processing unit is a multiple of 8, and

in a case where the image is a color image of YUV420, the number of pixels in the horizontal or vertical direction of the processing unit is a multiple of 4.

(11)

The image processing apparatus according to (9), wherein

in a case where the image is a color image of YUV422, the number of pixels in the horizontal direction of the processing unit is a multiple of 4, and the number of pixels in the vertical direction is a multiple of 8.

(12)

The image processing apparatus according to (9), wherein

in a case where the image is a color image of YUV444, the number of pixels in the horizontal or vertical direction of the processing unit is a multiple of 8.

(13)

An image processing method of causing an image processing apparatus to perform:

a decoding step of decoding encoding data and generating an image; and

a filter process step of performing a filter process in a processing unit regardless of a slice in parallel on the image generated in the decoding step.

(14)

A program to cause a computer to:

operate as a decoding unit which decodes encoding data and generates an image; and

operate as a filter processing unit which performs a filter process in a processing unit regardless of a slice in parallel on the image generated by the decoding unit.

(15)

An image processing apparatus including:

a decoding unit configured to decode encoding data and generate an image; and

a filter processing unit configured to perform a filter process in a processing unit regardless of a tile in parallel on the image generated by the decoding unit.

### REFERENCE SIGNS LIST

11 Encoding apparatus
40 Addition unit
41 Deblocking filter
42 Adaptive offset filter
43 Adaptive loop filter
112 Buffer
113-1 to 113-n Processor
160 Decoding apparatus
165 Addition unit
190 Encoding apparatus
193 Addition unit
195 Filter processing unit
230 Decoding apparatus
233 Addition unit

1. An image processing apparatus comprising:
a decoding unit configured to decode encoding data and generate an image; and
a filter processing unit configured to perform a filter process in a processing unit regardless of a slice in parallel on the image generated by the decoding unit, wherein
the filter processing unit includes
a storage unit configured to store a pixel value of a pixel in a boundary of the processing unit of the image, and
a processor configured to perform an adaptive offset filter process in the processing unit in parallel on the image using the pixel value stored by the storage unit.

2. The image processing apparatus according to claim 1, wherein.
the filter process is a deblocking filter process, and
the number of pixels in a horizontal or vertical direction of the processing unit is a multiple of 8.

3. The image processing apparatus according to claim 2, wherein
the pixels in the horizontal or vertical direction of the processing unit include four pixels with a boundary of an LCU (Largest Coding Unit) as the center.

4. The image processing apparatus according to claim 2, wherein
in a case where the image is a luminance image of YUV420, the number of pixels in the horizontal or vertical direction of the processing unit is a multiple of 8, and
in a case where the image is a color image of YUV420, the number of pixels in the horizontal or vertical direction of the processing unit is a multiple of 4.

5. The image processing apparatus according to claim 2, wherein
in a case where the image is a color image of YUV422, the number of pixels in the horizontal direction, of the processing unit is a multiple of 4, and the number of pixels in the vertical direction is a multiple of 8.

6. The image processing apparatus according to claim 2, wherein
in a case where the image is a color image of YUV444, the number of pixels in the horizontal or vertical direction of the processing unit is a multiple of 8.

7. (canceled)

8. The image processing apparatus according to claim 7, wherein
the processing unit is a largest coding unit (LCU).

9. The image processing apparatus according to claim 1, wherein
the filter process includes a deblocking filter process and an adaptive offset filter process, and
the number of pixels in a horizontal or vertical direction of the processing unit is a multiple of 8.

10. The image processing apparatus according to claim 9, wherein
in a case where the image is a luminance image of YUV420, the number of pixels in the horizontal or vertical direction of the processing unit is a multiple of 8, and
in a case where the image is a color image of YUV420, the number of pixels in the horizontal or vertical direction of the processing unit is a multiple of 4.

11. The image processing apparatus according to claim 9, wherein
in a case where the image is a color image of YUV422, the number of pixels in the horizontal direction of the processing unit is a multiple of 4, and the number of pixels in the vertical direction is a multiple of 8.

12. The image processing apparatus according to claim 9, wherein
in a case where the image is a color image of YUV444, the number of pixels in the horizontal or vertical direction of the processing unit is a multiple of 8.

13. An image processing method of causing an image processing apparatus to perform:
a decoding step of decoding encoding data and generating an image; and
a filter process step of performing a filter process in a processing unit regardless of a slice in parallel on the image generated in the decoding step, wherein
in the filter process step, an adaptive offset filter process is performed in the processing unit in parallel on the image using the pixel value stored in a storage unit configured to store a pixel value of a pixel in a boundary of the processing unit of the image.

14. A program to cause a computer to operate as an image processing apparatus, the program comprising:
a decoding unit configured to decode encoding data and generate an image; and
a filter processing unit configured to perform a filter process in a processing unit regardless of a slice in parallel on the image generated by the decoding unit, wherein
the filter processing unit performs an adaptive offset filter process in the processing unit in parallel on the image using a pixel value stored in a storage unit configured to store the pixel value of a pixel in a boundary of the processing unit of the image.

15. An image processing apparatus comprising:
a decoding unit configured to decode encoding data and generate an image; and
a filter processing unit configured to perform a filter process in a processing unit regardless of a tile in parallel on the image generated by the decoding unit.
